(19) United States
(12) Patent Application Publication
(10) Pub. No.: US 2026/0036214 A1
(43) Pub. Date: Feb. 5, 2026

(54) Y-Check Valves, Related Components, and Related Methods

(71) Applicant: Hayward Industries, Inc., Charlotte, NC (US)

(72) Inventors: Christopher Moncur, Pfafftown, NC (US); Benjamin Nowak, Clemmons, NC (US); Jon T. Stone, Clemmons, NC (US)

(73) Assignee: Hayward Industries, Inc., Charlotte, NC (US)

(21) Appl. No.: 19/276,784

(22) Filed: Jul. 22, 2025

Related U.S. Application Data
(60) Provisional application No. 63/678,759, filed on Aug. 2, 2024.

(51) Int. Cl. F16K 15/02; F16K 1/36

(52) U.S. Cl. CPC F16K 15/026; F16K 1/36

(57) ABSTRACT

Exemplary embodiments are directed to Y-check valves, generally including a body, nut, retainer, cage subassembly, disc, and spring. The retainer, cage subassembly, disc, and spring are positioned within a barrel leg of the body, with the disc positioned within the cage subassembly. The disc is movable between a first position in which it sealingly engages a sealing surface of the cage subassembly and prevents fluid backflow through the body and a second position in which it does not sealingly engage the sealing surface and permits fluid flow through the body. The spring biases the disc into the first position. The nut, retainer, cage subassembly, disc, and spring can be provided as an insert subassembly that is removable from the barrel leg as a single unit. The disc can be provided as a poppet valve stem and plug. Methods of assembling the exemplary Y-check valves are also provided.

### RELATED APPLICATIONS

This application claims the benefit of priority to U.S. Provisional Patent Application No. 63/678,759 filed on Aug. 2, 2024, which is incorporated herein by reference in its entirety.

### BACKGROUND

### Field of the Invention

The present disclosure relates to the field of flow control devices. More specifically, the present disclosure relates to improved Y-check valves that prevent backflow of fluid in a piping system and related components and methods.

### RELATED ART

Y-check valves are flow control devices that are used in various commercial and industrial applications, and can be installed in piping systems to allow the forward flow of fluid in the system, e.g., from an inlet of the Y-check valve to an outlet of the Y-check valve, but prevent, e.g., “check,” the back flow of fluid through the Y-check valve, e.g., from the outlet of the Y-check valve to the inlet of the Y-check valve, and the reversal of fluid flow through the piping system. Y-check valves are generally installed in piping systems where it is necessary to prevent backflow, such as, for example, in the piping on the discharge side of a pump to prevent draining of a system upon pump shutoff, or in the piping on the suction side of a pump to maintain prime.

Y-check valves known in the art commonly include a body, a disc, a spring, a barrel cap, seals, and end connections, which can be internal or external to the body and are generally designed to transition fluid between the Y-check valve and the piping system in which it is installed. The body generally includes three legs resembling a “Y” shape, including an inlet through which fluid enters the Y-check valve from an adjoined piping system, an outlet through which fluid exits the Y-check valve and re-enters the adjoined piping system, and a barrel leg that houses the check valve components, e.g., the seals, the disc, and the spring. The components positioned within the barrel leg are configured to allow fluid to open the valve from the inlet side and close the valve (or “check” fluid from reversing through the Y-check valve and flowing to the inlet side from the outlet side) with the use of gravity and the spring, which can be in contact with the disc and seals. In this regard, the spring and disc can operate in a generally vertical configuration such that gravity aids the force of the spring when closing the valve. Once forward flow in the piping system is started, e.g., due to activation of a pump, the disc of the Y-check valve opens in response to the fluid flow and pressure generated by the pump allowing the fluid to flow through the piping system and Y-check valve. Upon pump shutdown, gravity and the spring overcome the forward momentum of the fluid, which causes the disc to close and form a seal with a seal surface that prevents fluid backflow. Accordingly, Y-check valves are uni-directional valves that can be installed in piping systems to allow fluid to pass therethrough when open and prevent fluid back flow when closed without the need for manual, electric, or pneumatic means of operation, as they are controlled by fluid movement and pressure.

Y-check valves can come in various designs, sizes, and materials. For example, thermoplastic Y-check valves are known in the art, and provide corrosion resistance and reduced weight compared to metal counterparts.

However, notwithstanding the foregoing, some prior art Y-check valves are known to have an opening at the interface where the disc creates a seal that is insufficiently sized, thus causing a restriction in fluid flow and reducing flow through the internal sealing port. This can impact flow through the piping system in which the Y-check valve is installed, as well as operation of the other components installed in the piping system. Additionally, prior art Y-check valves are known to require additional machining for some parts thereof in order to create sufficiently smooth surfaces that provide an adequate seal for proper operation when installed. This additional machining can increase manufacturing time and costs. Furthermore, some prior art methods of assembling and disassembling spring and disc components of prior art Y-check valves are known to be difficult and require extra care in order to assure that none of the parts are mishandled, damaged, or dropped during the process. This can increase manufacturing time and costs.

Moreover, some prior art Y-check valves can be disassembled for maintenance. However, if pressure is built up in the piping system and the Y-check valve barrel prior to disassembly, then the barrel cap can suddenly dislodge during disassembly in the direction of the technician performing the maintenance.

Furthermore, some thermoplastic spring manufacturing methods are known to be difficult and time-consuming, which can result in added costs. Additionally, some spring manufacturing methods can involve exposure to high temperatures, as well as sharp and/or heavy tooling, which can present a safety issue.

Accordingly, there is a need for Y-check valves that address the foregoing and other needs.

### SUMMARY

The present disclosure relates to Y-check valves that prevent backflow of fluid in a piping system and related components and methods.

In accordance with aspects of the present disclosure, a Y-check valve for installation in a piping system is provided. The Y-check valve includes a body, a nut, a retainer, a retainer seal, a cage subassembly, a disc, and a spring. The body has an inlet port, an outlet port, a central portion extending between the inlet port and the outlet port, and a barrel leg. The central portion of the body defines a first chamber that places the inlet port in fluidic communication with the outlet port, while the barrel leg defines a second chamber that is in fluidic communication with the first chamber. The nut is removably fastened to a distal end of the barrel leg. The retainer is coupled to the nut and at least partially positioned within the second chamber defined by the barrel leg. The retainer seal forms a seal between the retainer and the barrel leg. The cage subassembly includes a sealing surface and a cage, which has a cylindrical body with a plurality of openings extending therethrough. The cage subassembly is engaged with the retainer and positioned within the second chamber defined by the barrel leg. Additionally, the cage subassembly forms a seal with an inner wall of the barrel leg. The disc is positioned within the cage subassembly, and is movable between a first position and a second position. When in the first position, the disc sealingly engages the sealing surface of the cage subassembly and prevents backflow of fluid through the body. When in the second position, the disc does not sealingly engage the sealing surface and fluid is permitted to flow through the body. The spring is positioned within the cage subassembly and biases the disc into the first position.

In some aspects, the barrel leg can interconnect with the central portion at an angle, which can be an acute angle.

In other aspects, the retainer can include a counter-bore that defines an internal chamber, and the spring can be at least partially inserted into the internal chamber and retained by the retainer. In such aspects, the spring can engage an interior surface of the retainer and can be compressible between the disc and the interior surface of the retainer. Additionally, the retainer can guide compression of the spring and prevent lateral displacement of the spring.

In some other aspects, the spring and the disc can be integrally formed as a single unit.

In still other aspects, the cage subassembly can includes a retainer end cap and a disc seal end cap. The retainer end cap can be engaged with a first end of the cylindrical body and interconnect the cage subassembly with the retainer, while the disc seal end cap can be engaged with a second end of the cylindrical body and include the sealing surface. In such aspects, the retainer end cap and the disc seal end cap can be spin welded to the cylindrical body. In other such aspects, the cage subassembly can include a cage seal that is positioned about the disc seal end cap. The cage seal can form a seal between the disc seal end cap and the inner wall of the barrel leg.

In some aspects, the disc can include an annular channel that receives a disc seal, which can form a seal between the disc and the sealing surface of the cage subassembly when the disc is in the first position. In such aspects, the disc can include a head that extends from an end wall, such that the annular channel is defined between the head and the end wall. The head can retain the disc seal in the annular channel when the disc is in the first position, and the end wall can retain the disc seal in the annular channel when the disc is in the second position. In other such aspects, the disc can define an internal cup that can receive fluid when the disc is in the first position and enhance the seal between the disc seal, the disc, and the sealing surface.

In some other aspects, the body can include a fillet between the barrel leg and the outlet port or the barrel leg and the central portion.

In still other aspects, the barrel leg can include an open end that is in fluidic communication with the second chamber defined by the barrel leg and threads on an exterior of the open end. The nut can include interior threads that are configured to engage the threads on the exterior of the open end of the barrel leg. In such aspects, the exterior threads of the barrel leg can be configured to expand into the interior threads of the nut when there is a surge of pressure in the barrel leg. Additionally, in such aspects, the exterior threads and the interior threads can be buttress threads.

In some aspects, the cage subassembly can include a retainer end cap that can be engaged with a first end of the cylindrical body and interconnect the cage subassembly with the retainer. In this regard, the retainer end cap can be removably engaged with the retainer. In such aspects, the retainer end cap can be removably engaged with the retainer with a snap-fit connection.

In other aspects, unfastening of the nut can cause the retainer, the cage subassembly, the disc, and the spring to be drawn out from the second chamber defined by the barrel leg, and a pressure relief passage to be formed.

In still other aspects, the Y-check valve can include a retainer seal that forms a seal between the retainer and the barrel leg, and unfastening of the nut can cause the seal between the retainer and the barrel leg formed by the retainer seal to be broken and a pressure relief passage to be formed. In such aspects, the retainer seal can be a piston seal or a face seal.

In some other aspects, the retainer seal can be positioned about a portion of the retainer and form a seal between the retainer and an interior wall of the barrel leg when the retainer is positioned within the second chamber defined by the barrel leg. In such aspects, the barrel leg can include a first bore, a second bore, and a chamfer between the first bore and the second bore. The retainer seal can form a seal between the retainer and the second bore. Additionally, in such aspects, the nut can be unfastened, e.g., from the barrel leg, to cause the retainer, the cage subassembly, the disc, the spring, and the retainer seal to be drawn out from the second chamber defined by the barrel leg. During this process, e.g., when the nut is unfastened and the retainer, the cage subassembly, the disc, the spring, and the retainer seal are drawn out from the second chamber defined by the barrel leg, the retainer seal can pass over the chamfer and a passage can be formed between the retainer seal and the first bore. The passage can allow for pressure within the barrel leg to be relieved therethrough. Additionally, when the retainer seal traverses the chamfer and the passage is formed, the nut can remain fastened to the distal end of the barrel, e.g., a threaded engagement between the nut and the distal end of the barrel can be maintained. Furthermore, the retainer seal can be a piston seal. In such aspects, the distal end of the barrel leg can be isolated from pressure within the second chamber defined by the barrel leg by the retainer seal.

In some aspects, the nut, the retainer, the cage subassembly, the disc, and the spring can be removable from the barrel leg as a single unit.

In some other aspects, the retainer can include first and second annular shoulders that can define an annular channel therebetween. The annular channel can be configured to receive a portion of the nut and permanently connect the nut and the retainer. In such aspects, the nut can include a top opening and a chamfered wall about the top opening, such that the nut and the retainer can be permanently connected by engaging the chamfered wall with the first annular shoulder of the retainer and forcing the first annular shoulder through the top opening causing the chamfered wall to snap over the first annular shoulder and into the annular channel. In such aspects, the nut can be capable of rotating freely about the retainer.

In still other aspects, the body can include a first tapped hole upstream of the barrel leg and a second tapped hole downstream of the barrel leg. In such aspects, the first and second tapped holes can be configured to each receive a pressure sensing device to measure differential pressure across the barrel leg.

In some aspects, the spring can be injection molded. In such aspects, the spring can be injection molded with a gate, a first spring portion extending from the gate to a first end, and a second spring portion extending from the gate to a second end. In some such aspects, the gate can be at a center of the spring. In other such aspects, the first spring portion and the second spring portion can have different internal diameters and/or different external diameters. In still other such aspects, at least one of an internal diameter of the first spring portion, an internal diameter of the second spring portion, an external diameter of the first spring portion, and an external diameter of the second spring portion can be tapered. Additionally and/or alternatively, the first spring portion can include a trapezoidal cross-section or a square cross-section, and the second spring portion can include a trapezoidal cross-section or a square cross-section.

In other aspects, the spring can be injection molded with an end gate and a variably decreasing cross-section.

A Y-check valve for installation in a piping system includes a body and a valve insert subassembly. The body has an inlet port, an outlet port, a central portion extending between the inlet port and the outlet port, and a barrel leg. The central portion of the body defines a first chamber that places the inlet port in fluidic communication with the outlet port, while the barrel leg defines a second chamber that is in fluidic communication with the first chamber. The valve insert subassembly includes a nut, a retainer, a retainer seal, a cage subassembly, a disc, and a spring. The nut is removably fastened to a distal end of the barrel leg. The retainer is coupled to the nut and at least partially positioned within the second chamber defined by the barrel leg. The retainer seal forms a seal between the retainer and the barrel leg. The cage subassembly includes a sealing surface and a cage, which has a cylindrical body with a plurality of openings extending therethrough. The cage subassembly is engaged with the retainer and positioned within the second chamber defined by the barrel leg. Additionally, the cage forms a seal with an inner wall of the barrel leg. The disc is positioned within the cage subassembly and is movable between a first position and a second position. When the disc is in the first position it sealingly engages the sealing surface of the cage subassembly and prevents a backflow of fluid through the body, and when it is in the second position it does not sealingly engage the sealing surface and fluid is permitted to flow through the body. The spring is positioned within the cage subassembly and biases the disc into the first position. The valve insert subassembly is removable from the barrel leg as a single unit.

In some aspects, the barrel leg can interconnect with the central portion at an angle, which can be an acute angle.

In other aspects, the retainer can include a counter-bore that defines an internal chamber, and the spring can be at least partially inserted into the internal chamber and retained by the retainer. In such aspects, the spring can engage an interior surface of the retainer and can be compressible between the disc and the interior surface of the retainer. Additionally, the retainer can guide compression of the spring and prevent lateral displacement of the spring.

In some other aspects, the spring and the disc can be integrally formed as a single unit.

In still other aspects, the cage subassembly can includes a retainer end cap and a disc seal end cap. The retainer end cap can be engaged with a first end of the cylindrical body and interconnect the cage subassembly with the retainer, while the disc seal end cap can be engaged with a second end of the cylindrical body and include the sealing surface. In such aspects, the retainer end cap and the disc seal end cap can be spin welded to the cylindrical body. In other such aspects, the cage subassembly can include a cage seal that is positioned about the disc seal end cap. The cage seal can form a seal between the disc seal end cap and the inner wall of the barrel leg.

In some aspects, the disc can include an annular channel that receives a disc seal, which can form a seal between the disc and the sealing surface of the cage subassembly when the disc is in the first position. In such aspects, the disc can include a head that extends from an end wall, such that the annular channel is defined between the head and the end wall. The head can retain the disc seal in the annular channel when the disc is in the first position, and the end wall can retain the disc seal in the annular channel when the disc is in the second position. In other such aspects, the disc can define an internal cup that can receive fluid when the disc is in the first position and enhance the seal between the disc seal, the disc, and the sealing surface.

In some other aspects, the body can include a fillet between the barrel leg and the outlet port or the barrel leg and the central portion.

In still other aspects, the barrel leg can include an open end that is in fluidic communication with the second chamber defined by the barrel leg and threads on an exterior of the open end. The nut can include interior threads that are configured to engage the threads on the exterior of the open end of the barrel leg. In such aspects, the exterior threads of the barrel leg can be configured to expand into the interior threads of the nut when there is a surge of pressure in the barrel leg. Additionally, in such aspects, the exterior threads and the interior threads can be buttress threads.

In some aspects, the cage subassembly can include a retainer end cap that can be engaged with a first end of the cylindrical body and interconnect the cage subassembly with the retainer. In this regard, the retainer end cap can be removably engaged with the retainer. In such aspects, the retainer end cap can be removably engaged with the retainer with a snap-fit connection.

In other aspects, unfastening of the nut can cause the retainer, the cage subassembly, the disc, and the spring to be drawn out from the second chamber defined by the barrel leg, and a pressure relief passage to be formed.

In still other aspects, the Y-check valve can include a retainer seal that forms a seal between the retainer and the barrel leg, and unfastening of the nut can cause the seal between the retainer and the barrel leg formed by the retainer seal to be broken and a pressure relief passage to be formed. In such aspects, the retainer seal can be a piston seal or a face seal.

In some other aspects, the retainer seal can be positioned about a portion of the retainer and form a seal between the retainer and an interior wall of the barrel leg when the retainer is positioned within the second chamber defined by the barrel leg. In such aspects, the barrel leg can include a first bore, a second bore, and a chamfer between the first bore and the second bore. The retainer seal can form a seal between the retainer and the second bore. Additionally, in such aspects, the nut can be unfastened, e.g., from the barrel leg, to cause the retainer, the cage subassembly, the disc, the spring, and the retainer seal to be drawn out from the second chamber defined by the barrel leg. During this process, e.g., when the nut is unfastened and the retainer, the cage subassembly, the disc, the spring, and the retainer seal are drawn out from the second chamber defined by the barrel leg, the retainer seal can pass over the chamfer and a passage can be formed between the retainer seal and the first bore. The passage can allow for pressure within the barrel leg to be relieved therethrough. Additionally, when the retainer seal traverses the chamfer and the passage is formed, the nut can remain fastened to the distal end of the barrel, e.g., a threaded engagement between the nut and the distal end of the barrel can be maintained. Furthermore, the retainer seal can be a piston seal. In such aspects, the distal end of the barrel leg can be isolated from pressure within the second chamber defined by the barrel leg by the retainer seal.

In some other aspects, the retainer can include first and second annular shoulders that can define an annular channel therebetween. The annular channel can be configured to receive a portion of the nut and permanently connect the nut and the retainer. In such aspects, the nut can include a top opening and a chamfered wall about the top opening, such that the nut and the retainer can be permanently connected by engaging the chamfered wall with the first annular shoulder of the retainer and forcing the first annular shoulder through the top opening causing the chamfered wall to snap over the first annular shoulder and into the annular channel. In such aspects, the nut can be capable of rotating freely about the retainer.

In still other aspects, the body can include a first tapped hole upstream of the barrel leg and a second tapped hole downstream of the barrel leg. In such aspects, the first and second tapped holes can be configured to each receive a pressure sensing device to measure differential pressure across the barrel leg.

In some aspects, the spring can be injection molded. In such aspects, the spring can be injection molded with a gate, a first spring portion extending from the gate to a first end, and a second spring portion extending from the gate to a second end. In some such aspects, the gate can be at a center of the spring. In other such aspects, the first spring portion and the second spring portion can have different internal diameters and/or different external diameters. In still other such aspects, at least one of an internal diameter of the first spring portion, an internal diameter of the second spring portion, an external diameter of the first spring portion, and an external diameter of the second spring portion can be tapered. Additionally and/or alternatively, the first spring portion can include a trapezoidal cross-section or a square cross-section, and the second spring portion can include a trapezoidal cross-section or a square cross-section.

A method of assembling a Y-check valve for installation in a piping system is provided. The method involves securing a nut to a retainer so as to form a retainer-nut subassembly. The method further involves inserting a disc into a cage subassembly that includes a sealing surface and a cage having a cylindrical body with a plurality of openings extending therethrough. The method also involves inserting a spring into the cage subassembly and into engagement with the disc. The method further involves forming a valve insert subassembly by securing the cage subassembly to the retainer-nut subassembly with the disc and spring positioned therebetween and the spring biasing the disc into sealing engagement with the sealing surface. The method involves inserting at least a portion of the valve insert subassembly, including the cage subassembly, the disc, and the spring, through an opening in a barrel leg of a body and into a first chamber defined by the barrel leg, which is in fluidic communication with a second chamber that (i) is defined by a central portion of the body extending between an inlet port and an outlet port and (ii) places the inlet port in fluidic communication with the outlet port. The method also involves coupling the nut to the barrel leg so as to removably fasten the retainer-nut subassembly to the body with the disc, spring, cage subassembly, and retainer at least partially positioned within the first chamber, and with the cage subassembly forming a seal with an inner wall of the barrel leg and a retainer seal forming a seal between the retainer and the barrel leg.

In some aspects, the method can include inserting a first end of the cylindrical body of the cage into a retainer end cap and inserting a second end of the cylindrical body of the cage into a disc seal end cap so as to form the cage subassembly between the retainer end cap, the cage, and the disc seal end cap. The method can also include securing the retainer end cap of the cage subassembly to the retainer of the retainer-nut subassembly so as to form the valve insert subassembly. In such methods, the disc seal end cap can include the sealing surface. In such aspects, the method can also include affixing the retainer end cap to the first end of the cage and affixing the disc seal end cap to the second end of the cage. In other such aspects, the method can include installing a cage seal about the disc seal end cap. The cage seal can form a seal between the disc seal end cap and the inner wall of the barrel leg when the cage subassembly is positioned within the first chamber.

In other aspects, the barrel leg can interconnect with the central portion at an angle, which can be an acute angle.

In still other aspects, the method can involve inserting at least a portion of the spring into an internal chamber defined by a bore of the retainer and retaining the spring with the retainer. In such aspects, the method can also involve engaging an interior surface of the retainer with the spring such that the spring is compressible between the disc and the interior surface of the retainer. In such aspects, the retainer can guide compression of the spring and prevent lateral displacement of the spring.

In some other aspects, the method can involve installing a disc seal in an annular channel defined by the disc. The disc seal can form a seal between the disc and the sealing surface of the cage subassembly when the disc is biased by the spring into sealing engagement with the sealing surface. In such aspects, the disc can include a head extending from an end wall, the annular channel can be defined between the head and the end wall, the head can retain the disc seal in the annular channel when the disc is in the first position, and the end wall can retain the disc seal in the annular channel when the disc is in the second position. In additional such aspects, the disc can define an internal cup that receives fluid and enhances the seal between the disc seal, the disc, and the sealing surface.

In other aspects, the body can include a fillet between the barrel leg and the outlet port or the barrel leg and the central portion.

In some other aspects, the barrel leg can include an open end in fluidic communication with the second chamber defined by the barrel leg and threads on an exterior of the open end, the nut can include interior threads configured to engage the threads on the exterior of the open end of the barrel leg, and the exterior threads of the barrel leg can be configured to expand into the interior threads of the nut when there is a surge of pressure in the barrel leg. In such aspects, the exterior threads and the interior threads can be buttress threads.

In still other aspects, the method can include inserting an end of the cylindrical body of the cage into a retainer end cap and securing the retainer end cap of the cage subassembly to the retainer of the retainer-nut subassembly so as to form the valve insert subassembly. In such aspects, the action of securing the retainer end cap of the cage subassembly to the retainer of the retainer-nut subassembly can include removably securing the retainer end cap of the cage subassembly to the retainer of the retainer-nut subassembly with a snap-fit connection.

In other aspects, the method can involve unfastening the nut from the barrel leg thereby causing the retainer, the cage subassembly, the disc, and the spring to be drawn out from the second chamber defined by the barrel leg, and a pressure relief passage to be formed.

In still other aspects, the method can involve unfastening the nut from the barrel leg, and causing the seal between the retainer and the barrel leg formed by the retainer seal to be broken and a pressure relief passage to be formed. In such aspects, the retainer seal can be a piston seal or a face seal.

In some aspects, the method can include positioning the retainer seal about a portion of the retainer and forming a seal between the retainer and an interior wall of the barrel leg with the retainer seal when the retainer is at least partially positioned within the first chamber. In such aspects, the barrel leg can include a first bore, a second bore, and a chamfer between the first bore and the second bore, and the seal can be formed between the retainer and the second bore. Additionally, in such aspects, the method can include unfastening the nut from the barrel leg so as to cause the nut, the retainer, the cage subassembly, the disc, the spring, and the retainer seal to be drawn out from the second chamber defined by the barrel leg. Additionally, such methods can include causing the retainer seal to traverse the chamfer as the nut is unfastened from the barrel leg, forming a passage between the retainer seal and the first bore as the retainer traverses the chamfer, and relieving pressure built-up in the barrel leg through the passage. In such aspects, the nut can remain fastened to the barrel leg when the passage is formed and the pressure is relieved. In some other such aspects, the method can include, removing the nut, the retainer, the cage subassembly, the disc, the spring, and the retainer seal from the barrel leg as a single unit, while in other aspects, the method can include isolating, with the retainer seal, which can be a piston seal, a distal end of the barrel leg from pressure within the first chamber defined by the barrel leg.

In other aspects, the method can include engaging a first annular shoulder of the retainer with a chamfered wall of the nut that surrounds a top opening of the nut and forcing the first annular shoulder through the top opening so as to cause the chamfered wall to snap over the first annular shoulder and into an annular channel of the retainer, which can be defined by the first annular shoulder and a second annular shoulder. In such aspects, the nut can be capable of rotating freely about the retainer.

In some other aspects, the method can include forming a first tapped hole in the body upstream of the barrel leg, forming a second tapped hole in the body downstream of the barrel leg, engaging a first pressure sensing device with the first tapped hole, and engaging a second pressure sensing device with the second tapped hole. In such aspects, the first and second pressure sensing devices can allow a differential pressure across the barrel leg to be measured.

In still other aspects, the spring can be injection molded.

A Y-check valve for installation in a piping system includes a body, a nut, a retainer, a stem guide, a poppet valve stem, a plug, and a spring. The body has an inlet port, an outlet port, a central portion extending between the inlet port and the outlet port, and a barrel leg. The central portion defines a first chamber that places the inlet port in fluidic communication with the outlet port while the barrel leg defines a second chamber that is in fluidic communication with the first chamber. The nut is removably fastened to a distal end of the barrel leg. The retainer is coupled to the nut and at least partially positioned within the second chamber defined by the barrel leg. The stem guide, which includes at least one aperture, is engaged with the retainer and positioned within the second chamber defined by the barrel leg. The poppet valve stem extends between a first end and a second end, and through the at least one aperture of the stem guide. The plug is connected to the second end of the poppet valve stem and is positioned within the second chamber defined by the barrel leg. The plug is movable between a first position in which the plug sealingly engages an inner wall of the barrel leg and prevents the backflow of fluid through the body, and a second position in which the plug does not sealingly engage the inner wall of the barrel leg and fluid is permitted to flow through the body. The spring is positioned within the cage subassembly around the poppet valve stem and biases the plug into the first position. The poppet valve stem moves within the at least one aperture of the stem guide when the plug moves between the first position and the second position.

In some aspects, the barrel leg can interconnect with the central portion at an angle, which can be an acute angle.

In some other aspects, the retainer can include a counter-bore that defines an internal chamber, and the poppet valve stem can be at least partially inserted into the internal chamber when the plug is in the second position.

In still other aspects, the spring can engage the stem guide and can be compressible between the stem guide and the plug.

In other aspects, the Y-check valve can include a plug seal that can be received by the plug and form a seal between the plug and the inner wall of the barrel leg when the disc is in the first position. In such aspects, the plug can include a body, a head connected to the body by a neck, and a circumferential grooved formed between the body and the head, which can receive the plug seal. In such aspects, the plug seal can be compressed between the body and the inner wall of the barrel leg when the disc is in the first position. In some other such aspects, the inner wall of the barrel leg can be an end wall of the barrel leg, and the plug seal can be a face seal.

In some other aspects, the Y-check valve can include a retainer seal that can be positioned about a portion of the retainer and form a seal between the retainer and an interior wall of the barrel leg when the retainer is positioned within the second chamber defined by the barrel leg.

In still other aspects, the nut, the retainer, the stem guide, the plug, the poppet valve stem, and the spring can be removable from the barrel leg as a single unit.

In some other aspects, the retainer can include a plurality of pliable fingers that are configured to snap into engagement with the nut to removably connect the nut and the retainer.

A Y-check valve for installation in a piping system includes a body, a nut, a retainer, a cage, a disc, and a spring. The body has an inlet port, an outlet port, a central portion that extends between the inlet port and the outlet port, and a barrel leg that extends from the central portion. The central portion defines a first chamber that places the inlet port in fluidic communication with the outlet port while the barrel leg defines a second chamber that is in fluidic communication with the first chamber. The nut is removably fastened to a distal end of the barrel leg. The retainer is coupled to the barrel nut and positioned within the second chamber defined by the barrel leg. The cage includes a plurality of ribs that extend from a first end of the cage to a second end of the cage and define at least one window. The cage is engaged with the retainer at the first end thereof and is positioned within the second chamber defined by the barrel leg. The disc seal end cap defines an internal sealing surface, is engaged with the second end of the cage, and forms a seal with an inner wall of the barrel leg. The disc is positioned within the cage and is movable between a first position in which it sealingly engages the sealing surface of the disc seal end cap and prevents the backflow of fluid through the body, and a second position in which it does not sealingly engage the sealing surface and fluid is permitted to flow through the body. The spring is positioned within the cage and biases the disc into the first position. The cage receives the spring and the disc through the at least one window during construction of the Y-check valve.

In some aspects, the barrel leg can interconnect with the central portion at an angle, which can be an acute angle.

In some other aspects, the cage can include an internal wall, while the spring can engage the internal wall and can be compressible between the internal wall and the disc.

In still other aspects, the Y-check valve can include a cage seal that can be positioned about the disc seal end cap and form a seal between the disc seal end cap and the inner wall of the barrel leg.

In some other aspects, the disc can include an annular channel that can receive a disc seal, which can form a seal between the disc and the internal sealing surface of the disc seal end cap when the disc is in the first position. In such aspects, the disc can include a head that extends from a closed end and the annular channel can be defined between the head and the end wall. In some other such aspects, the Y-check valve can include a retainer seal that can be positioned about a portion of the retainer and form a seal between the retainer and an interior wall of the barrel leg when the retainer is positioned within the second chamber defined by the barrel leg.

In some aspects, the nut, the retainer, the cage, the plug, the disc seal end cap, the disc, and the spring can be removable from the barrel leg as a single unit.

In some other aspects, the retainer can include a plurality of pliable fingers that are configured to snap into engagement with the nut to removably connect the nut and the retainer.

A method of assembling a Y-check valve for installation in a piping system includes securing a nut to a retainer so as to form a retainer-nut subassembly and installing a retainer seal in a circumferential channel of the retainer. The method further includes securing a first end of a cage to the retainer-nut subassembly. The cage includes a plurality of ribs that extend from the first end of the cage to a second end of the cage and define at least one window. The method also includes securing a disc seal end cap, which defines an internal sealing surface, to the second end of the cage. The method further includes inserting a disc including a disc seal into the cage through the at least one window and inserting the spring into the cage through the at least one window and into engagement with the disc so that the spring biases the disc into sealing engagement with the internal sealing surface. The method also involves inserting the disc seal end cap, the disc, the disc seal, the spring, the cage, the retainer, and the retainer seal through an opening in a barrel leg of a body and into a first chamber defined by the barrel leg, which is in fluidic communication with a second chamber that (i) is defined by a central portion of the body extending between an inlet port and an outlet port and (ii) places the inlet port in fluidic communication with the outlet port. The method further involves coupling the nut to the barrel leg to removeably fasten the retainer-nut subassembly to the body such that the disc seal end cap, the disc, the spring, the cage, the retainer, and the retainer seal are positioned within the first chamber and the disc seal end cap forms a seal with an inner wall of the barrel leg.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the invention will be apparent from the following Detailed Description, taken in connection with the accompanying drawings, in which:

FIG. 1 is a bottom perspective view of an exemplary Y-check valve of the present disclosure;

FIG. 2 is a side view of the exemplary Y-check valve of FIG. 1;

FIG. 3 is a top plan view of the exemplary Y-check valve of FIG. 1;

FIG. 4 is an exploded view of the exemplary Y-check valve of FIG. 1;

FIG. 5A is a side perspective view of a body of the exemplary Y-check valve of FIG. 1;

FIG. 5B is a sectional view of the body of FIG. 5A taken along line 5B-5B of FIG. 5A;

FIG. 6 is a side perspective view of a first alternative body according to the present disclosure;

FIG. 7 is a side perspective view of a second alternative body according to the present disclosure;

FIG. 8A is a perspective view of a retainer of the exemplary Y-check valve of FIG. 1;

FIG. 8B is a front view of the retainer of FIG. 8A;

FIG. 8C is a side view of the retainer of FIG. 8A;

FIG. 8D is a sectional view of the retainer of FIG. 8A taken along line 8D-8D of FIG. 8C;

FIG. 9A is a perspective view of a barrel nut of the exemplary Y-check valve of FIG. 1;

FIG. 9B is a side view of the barrel nut of FIG. 9A;

FIG. 9C is a top view of the barrel nut of FIG. 9A;

FIG. 9D is a sectional view of the barrel nut of FIG. 9A taken along line 9D-9D of FIG. 9C;

FIG. 10A is a perspective view of a retainer-barrel nut subassembly of the exemplary Y-check valve of FIG. 1;

FIG. 10B is a side view of the retainer-barrel nut subassembly of FIG. 10A;

FIG. 10C is a sectional view of the retainer-barrel nut subassembly of FIG. 10A taken along line 10C-10C of FIG. 10B;

FIG. 11A is a top perspective view of a retainer end cap of the exemplary Y-check valve of FIG. 1;

FIG. 11B is a bottom perspective view of the retainer end cap of FIG. 11A;

FIG. 11C is a top view of the retainer end cap of FIG. 11A;

FIG. 11D is a side view of the retainer end cap of FIG. 11A;

FIG. 11E is a sectional view of the retainer end cap of FIG. 11A taken along line 11E-11E of FIG. 11C;

FIG. 12A is a bottom perspective view of a disc seal end cap of the exemplary Y-check valve of FIG. 1;

FIG. 12B is a top perspective view of the disc seal end cap of FIG. 12A;

FIG. 12C is a bottom view of the disc seal end cap of FIG. 12A;

FIG. 12D is a side view of the disc seal end cap of FIG. 12A;

FIG. 12E is a sectional view of the disc seal end cap of FIG. 12A taken along line 12E-12E of FIG. 12C;

FIG. 13 is a side view of a cage of the exemplary Y-check valve of FIG. 1;

FIG. 14A is a perspective view of a cage subassembly of the exemplary Y-check valve of FIG. 1;

FIG. 14B is a side view of the cage subassembly of FIG. 14A;

FIG. 15A is a side perspective view of a disc of the exemplary Y-check valve of FIG. 1;

FIG. 15B is a top perspective view of the disc of FIG. 15A;

FIG. 15C is a side view of the disc of FIG. 15A;

FIG. 15D is a sectional view of the disc of FIG. 15A taken along line 15D-15D of FIG. 15C;

FIG. 16A is a perspective view of a spring of the exemplary Y-check valve of FIG. 1;

FIG. 16B is a side view of the spring of FIG. 16A;

FIG. 16C is a sectional view of the spring of FIG. 16A taken along line 16C-16C of FIG. 16B;

FIG. 17A is a perspective view of a valve insert subassembly of the exemplary Y-check valve of FIG. 1;

FIG. 17B is a side view of the valve insert subassembly of FIG. 17A;

FIG. 17C is a sectional view of the valve insert subassembly of FIG. 17A taken along line 17C-17C of FIG. 17B;

FIG. 17D is the sectional view of FIG. 17C illustrating an alternative means of connecting components of the valve insert subassembly;

FIG. 18A is a sectional view of the exemplary Y-check valve of FIGS. 1-4 taken along line 18A-18A of FIG. 3 showing the exemplary Y-check valve in a first, e.g., closed, position;

FIG. 18B is a sectional view of the exemplary Y-check valve of FIGS. 1-4 taken along line 18A-18A of FIG. 1 showing the exemplary Y-check valve in a second, e.g., open, position;

FIG. 18C is a sectional view of the exemplary Y-check valve of FIGS. 1-4 taken along line 18A-18A of FIG. 3 showing the removal of components from the body thereof and the formation of a pressure relief passage;

FIG. 19 is a perspective view of an exemplary integral spring and disc of the present disclosure;

FIG. 20A is a side view of another exemplary spring of the present disclosure;

FIG. 20B is a sectional view of the exemplary spring of FIG. 20A;

FIG. 21A is a side view of another exemplary spring of the present disclosure;

FIG. 21B is a sectional view of the exemplary spring of FIG. 21A;

FIG. 22A is side view of another exemplary spring of the present disclosure;

FIG. 22B is a sectional view of the exemplary spring of FIG. 22A;

FIG. 23A is a side view of another exemplary spring of the present disclosure;

FIG. 23B is a sectional view of the exemplary spring of FIG. 23A;

FIG. 24 is a side view of another exemplary spring of the present disclosure;

FIG. 25 is a side view of another exemplary spring of the present disclosure;

FIG. 26A is a bottom perspective view of another exemplary Y-check valve of the present disclosure;

FIG. 26B is a top view of the exemplary Y-check valve of FIG. 26A;

FIG. 26C is an exploded view of the exemplary Y-check valve of FIG. 26A;

FIG. 26D is a sectional view of the exemplary Y-check valve of FIG. 26A taken along line 26D-26D of FIG. 26B;

FIG. 26E is an exploded view of FIG. 26D;

FIG. 27A is a bottom perspective view of another exemplary Y-check valve of the present disclosure;

FIG. 27B is a top view of the exemplary Y-check valve of FIG. 27A;

FIG. 27C is an exploded view of the exemplary Y-check valve of FIG. 27A;

FIG. 27D is a sectional view of the exemplary Y-check valve of FIG. 27A taken along line 27D-27D of FIG. 27B; and

FIG. 27E is an exploded view of FIG. 27D.

### DETAILED DESCRIPTION

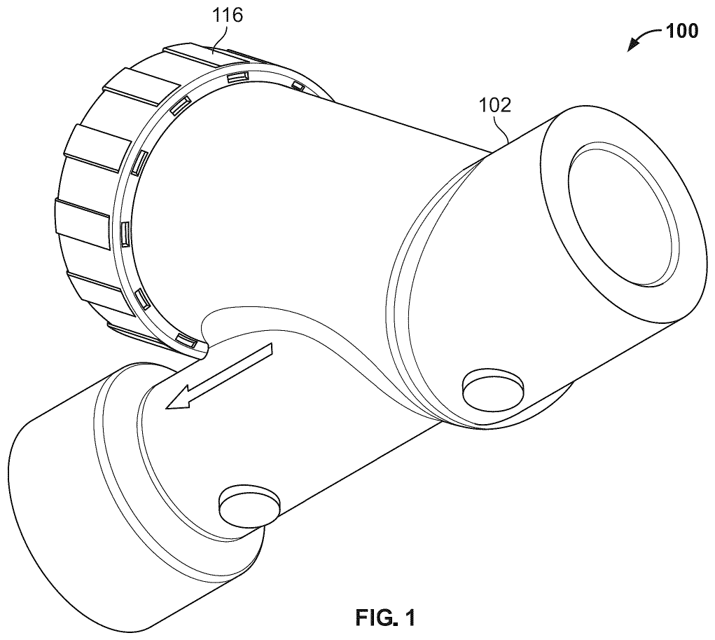

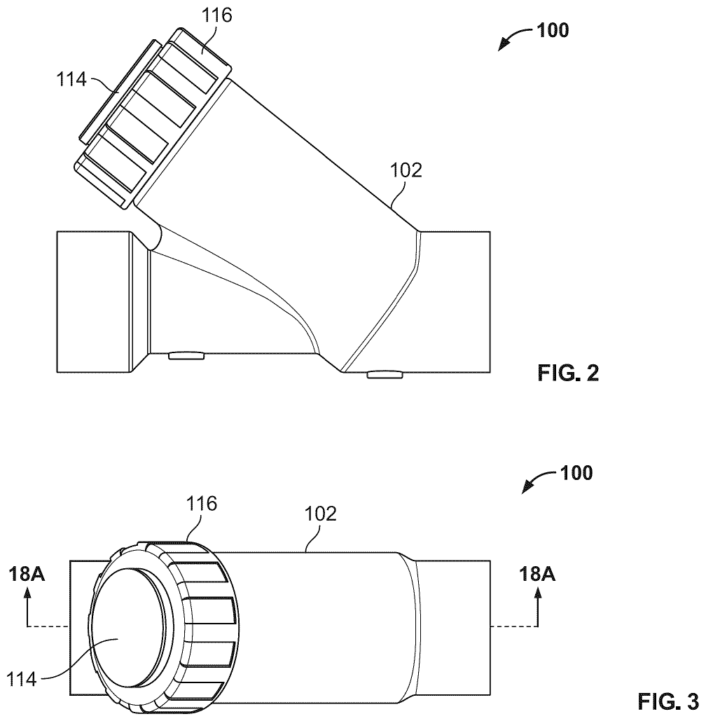

The present disclosure relates to Y-check valves and related components and methods, as discussed in detail below in connection with FIGS. 1-27E.

It should be understood that the relative terminology used herein, such as “front,” “rear,” “left,” “top,” “bottom,” “vertical,” and “horizontal” is solely for the purposes of clarity and designation and is not intended to limit the invention to embodiments having a particular position and/or orientation. Accordingly, such relative terminology should not be construed to limit the scope of the present invention. In addition, it should be understood that the invention is not limited to embodiments having specific dimensions. Thus, any dimensions provided herein are merely for an exemplary purpose and are not intended to limit the invention to embodiments having particular dimensions.

FIGS. 1-4 are, respectively, bottom perspective, side, top, and exploded views of an exemplary Y-check valve 100 of the present disclosure. The Y-check valve 100 can be utilized in fluid systems to permit fluid to flow in a forward direction while preventing fluid from flowing in a reverse direction. That is, the Y-check valve 100 can be utilized to prevent fluid backflow in a fluid system.

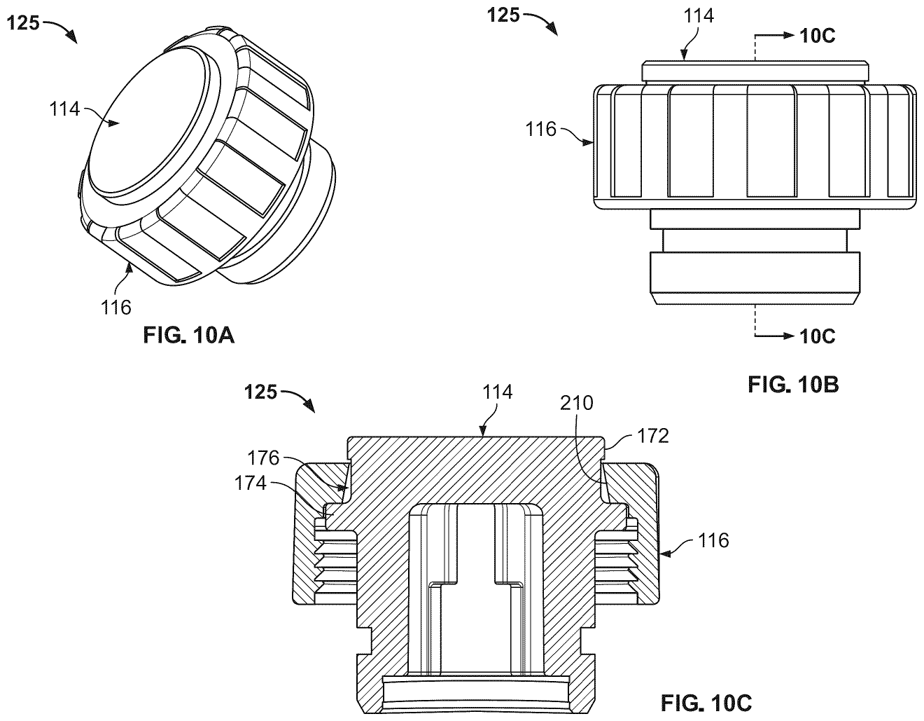

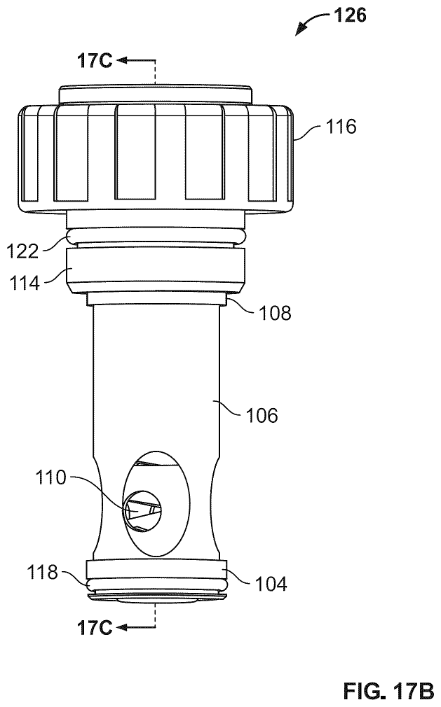

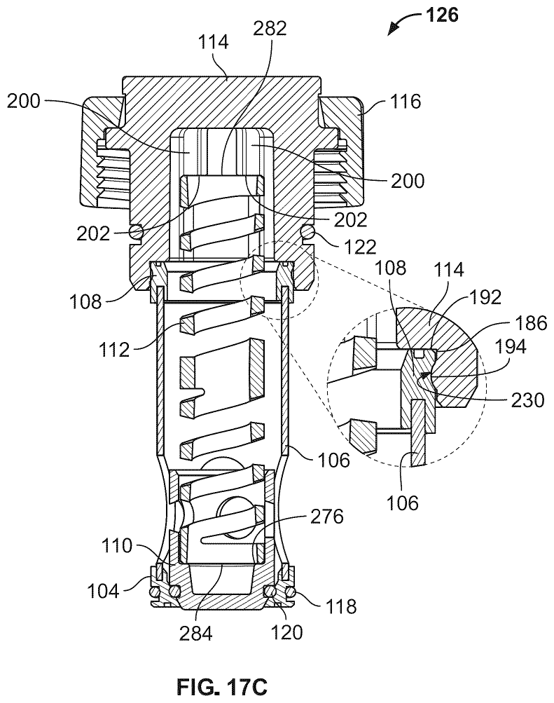

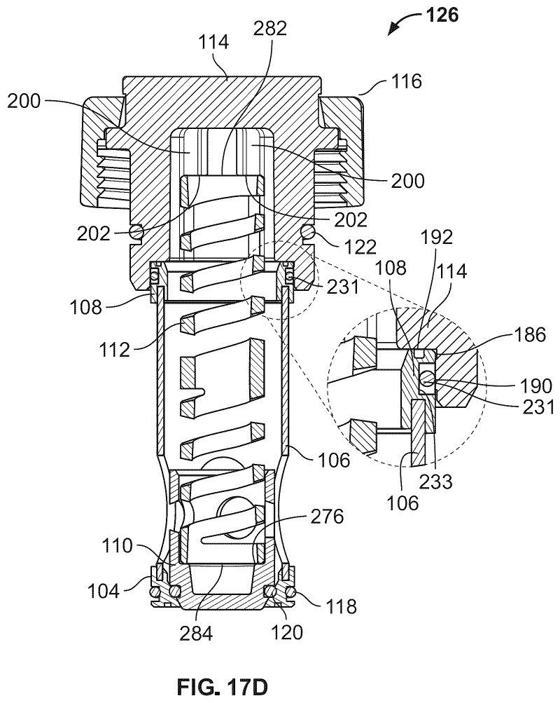

The exemplary Y-check valve 100 includes a body 102, a disc seal end cap 104, a cage 106, a retainer end cap 108, a disc 110, a spring 112, a retainer 114, a barrel nut 116, a cage seal 118, a disc seal 120, and a retainer seal 122. The disc seal end cap 104, cage 106, retainer end cap 108, and cage seal 118, can form a cage subassembly 124, which is shown and described in greater detail in connection with FIGS. 14A and 14B. The retainer 114 and barrel nut 116 can form a retainer-barrel nut subassembly 125, which is shown and described in greater detail in connection with FIGS. 10A-10C. Additionally, the disc seal end cap 104, cage 106, retainer end cap 108, disc 110, spring 112, retainer 114, barrel nut 116, and seals 118, 120, 122 can form a valve insert subassembly 126, which is shown and described in greater detail in connection with FIGS. 17A-C. In this regard, the disc seal end cap 104, cage 106, retainer end cap 108, disc 110, spring 112, retainer 114, barrel nut 116, and seals 118, 120, 122 can be aligned along axis A₁.

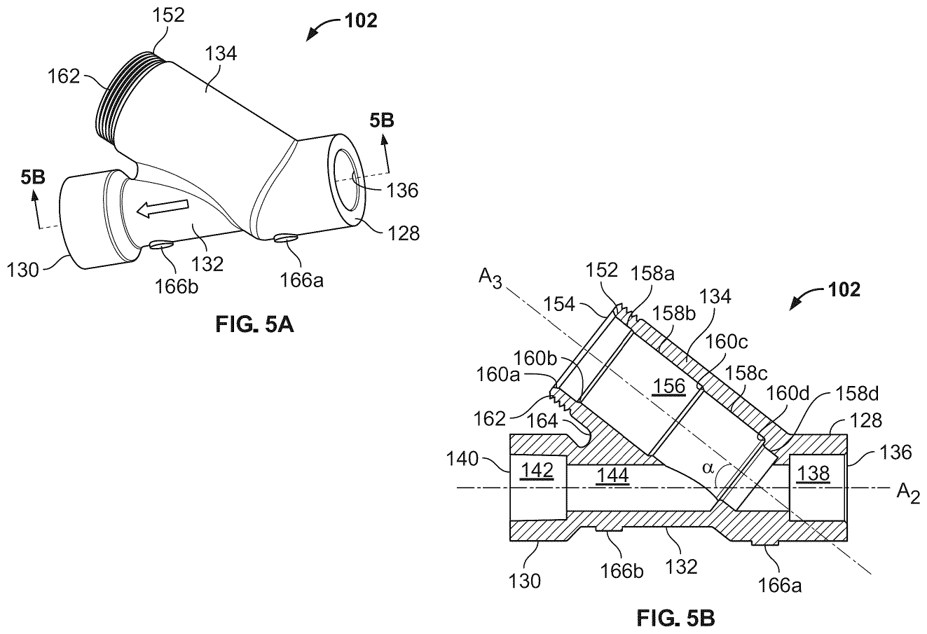

FIGS. 5A and 5B are perspective and cross-sectional views of the body 102, respectively. The body 102 is the primary structural component of the Y-check valve 100 and includes an inlet port 128, an outlet port 130, a central portion 132, and a barrel leg 134. The inlet port 128 can be generally tubular in shape and defines an inlet opening 136 and an inlet flow chamber 138 while the outlet port 130 can also be generally tubular in shape and defines an outlet opening 140 and an outlet flow chamber 142. The central portion 132 extends between the inlet port 128 and the outlet port 130, and defines a central flow chamber 144 that is in fluidic communication with the inlet flow chamber 138 and the outlet flow chamber 142. The inlet flow chamber 138, central flow chamber 144, and outlet flow chamber 142 can be coaxial with each other along axis A₂. Accordingly, the inlet flow chamber 138, central flow chamber 144, and outlet flow chamber 142 together form a passage for fluid to flow through the body 102.

In this regard, the body 102 can be installed in a piping system in the same direction/orientation as an inlet-side pipe of the piping system, such that the inlet port 128 is connectable to the inlet-side pipe while the outlet port 130 is connectable to an outlet-side pipe of the piping system. Thus, the inlet port 128 is configured to accept the flow of fluid from the piping system while the outlet port 130 is configured to discharge fluid into the piping system. Accordingly, fluid can flow into the body 102 through the inlet opening 136, through the inlet flow chamber 138, through the central flow chamber 144, through the outlet flow chamber 142, and exit through the outlet opening 140.

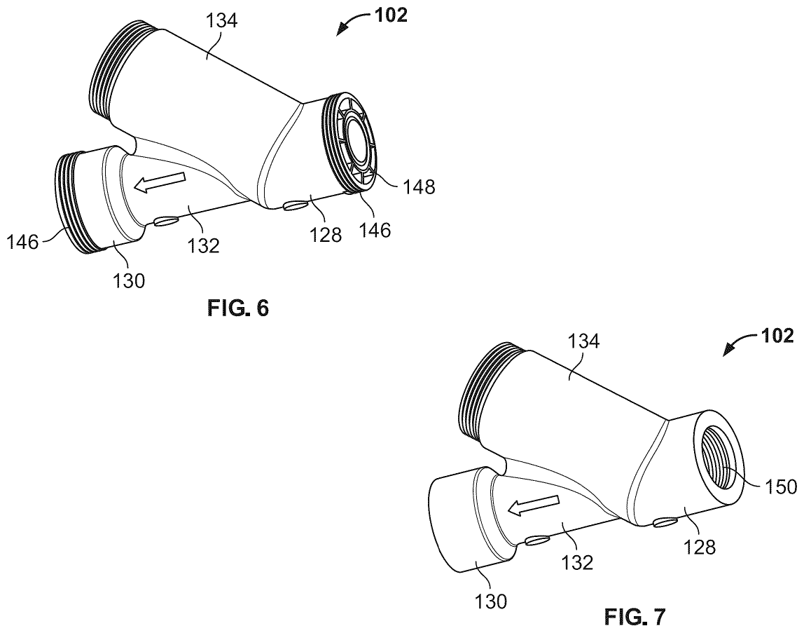

The inlet and outlet ports 128, 130 can be designed and manufactured to accommodate different end connections that will transition flow from the piping system when installed. For example, as shown in FIGS. 5A and 5B, the inlet and outlet ports 128, 130 can be provided as internal socket end connections such that the inlet opening 136 and the outlet opening 140 are of sufficient size to accept a pipe of the piping system therein, which can be cemented in place. Thus, the inlet flow chamber 138 and the outlet flow chamber 142 can have a larger diameter than the central flow chamber 144. Alternatively, as shown in FIG. 6, the exterior surface of the inlet and outlet ports 128, 130 can have external threading 146 that is configured to accept true union end connections, e.g., the external threading 146 is configured to be engaged by a threaded nut (not shown), and a front face 148 of each of the inlet and outlet ports 128, 130 can be configured to engage an end connector (not shown) with an o-ring or other gasket positioned therebetween in an annular channel of the front face 148. Thus, the inlet and outlet ports 128, 130 of the alternative body 102 shown in FIG. 6 can be secured to end connectors by way of threaded nuts that are positioned over the end connectors and engage the external threading 146 of the inlet and outlet ports 128, 130. As another alternative, as shown in FIG. 7, the interior surface of the inlet and outlet ports 128, 130 can have internal threading 150, which can be engaged by an externally threaded pipe in order to secure the pipe to the body 102. It should be understood that the present application should not be limited to the foregoing end connections, and other end connections known in the art can be applied to the body 102 and thus fall within the scope of the present disclosure. Additionally, different sized end connections, e.g., the inlet and outlet ports 128, 130, can be provided depending on the piping system in which the Y-check valve 100 is being installed.

The barrel leg 134 is a generally cylindrical component that houses the working valve components, e.g., the disc seal end cap 104, cage 106, retainer end cap 108, disc 110, spring 112, retainer 114, and seals 118, 120, 122, allows for sealing of the Y-check valve 100 once assembled, and provides access to the working valve components for maintenance and replacement. The barrel leg 134 has a central axis A₃ and interconnects with the central portion 132 of the body 102 at an angle with respect to the inlet and outlet ports 128, 130 to decrease any interrupted flow of the system as fluid passes through the Y-check valve 100. In particular, the barrel leg 134 interconnects to the remainder of the body 102 at an angle α, which is the angle between the axis A₂ of the inlet port 128, central portion 132, and outlet port 130 and the central axis A₃ of the barrel leg 134. The angle α of the barrel leg 134 is approximately 38°, which is less than, e.g., more acute than, prior art Y-check valves and increases the flow capacity of the Y-check valve 100 compared to prior art Y-check valves. However, angle α can be any acute angle, e.g., any angle greater than 1° and less than 90°, as desired. An internal diameter of the barrel leg 134 can be increased to allow for increased flow. The angle at which the barrel leg 134 interconnects with the central portion 132 of the body 102 allows for a majority of the flow to pass straight through the Y-check valve 100, allowing for improved flow. Additionally, an internal diameter of the barrel leg 134 can be increased to allow for increased flow.

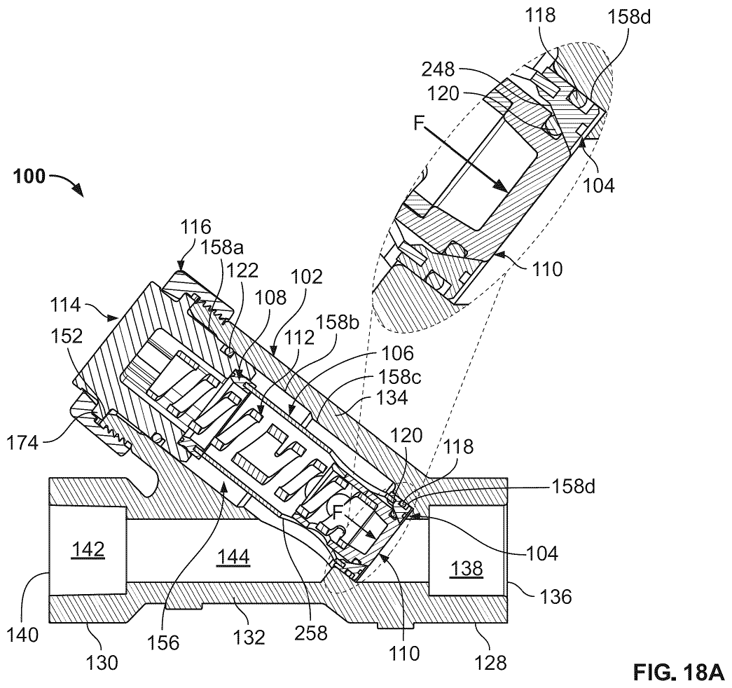

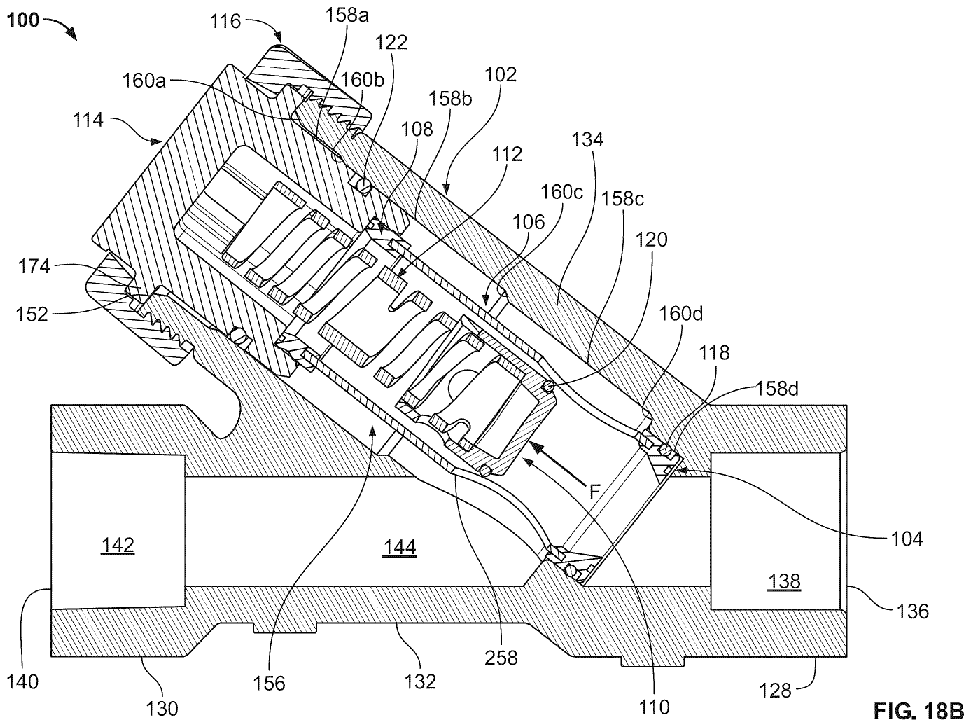

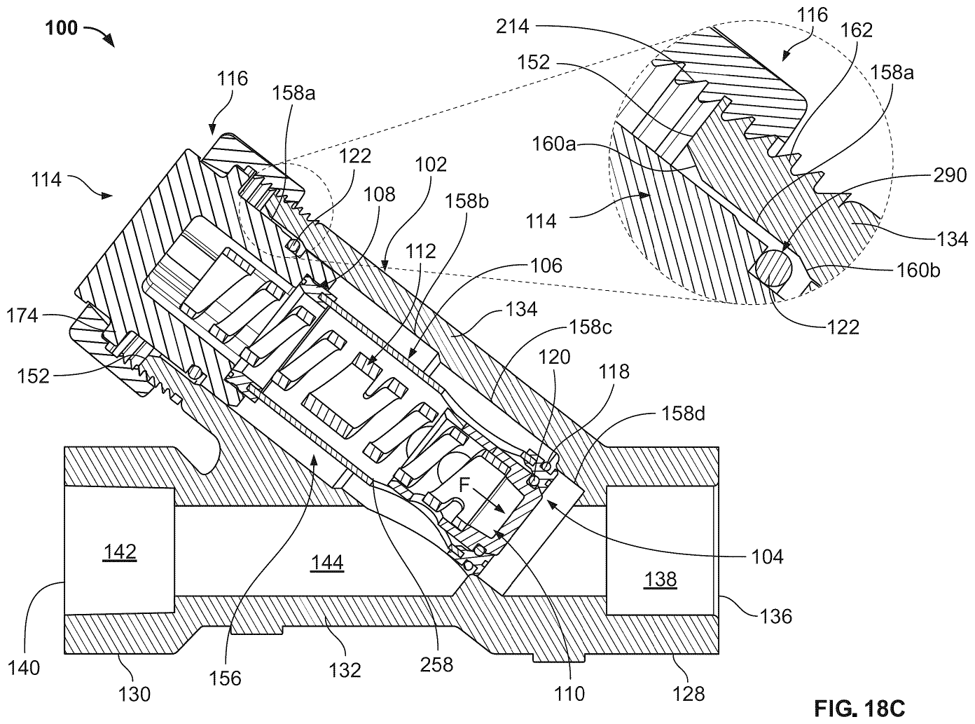

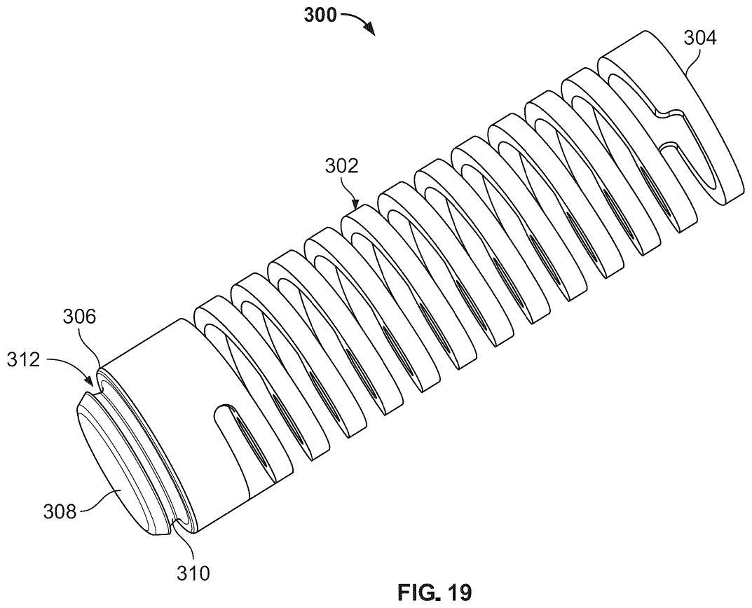

The barrel leg 134 includes an open end 152 defining an opening 154 in fluidic communication with a central chamber 156 that is defined by a series of four internal bores 158a-d of decreasing diameter. The open end 152 includes a first chamfer 160a, which accepts and assists with insertion of the working valve components, e.g., the retainer 114, during the valve assembly process. The barrel leg 134 additionally includes a second chamfer 160b between the first and second bores 158a, 158b, and can include a third chamfer 160c between the second and third bores 158b, 158c and a fourth chamfer 160d between the third and fourth bores 158c, 158d. The second chamfer 160b is designed to relieve pressure when disassembling the Y-check valve 100, which is shown and discussed in greater detail below in connection with FIG. 18C. The central chamber 156 of the barrel leg 134 is generally larger in diameter than that of prior art Y-check valves to allow for increased flow. However, it should be understood that the diameter of the central chamber 156 can be designed according to the installation and piping system needs. The central chamber 156 intersects and is in fluidic communication with the central flow chamber 144. In particular, the central chamber 156 of the barrel leg 134 can extend into the central flow chamber 144 so that fluid can flow straight through the central chamber 156 when flowing through the Y-check valve 100.

The open end 152 of the barrel leg 134 includes external threads 162 that are configured to engage internal threads of the barrel nut 116 to assemble the Y-check valve 100 and secure the working valve components, e.g., the disc seal end cap 104, cage 106, retainer end cap 108, disc 110, spring 112, retainer 114, and seals 118, 120, 122, within the barrel leg 134. Since the external threads 162 are positioned on the exterior of the open end 152, as opposed to the interior, the external threads 162 will expand into the barrel nut 116 when there is a surge in pressure inside the body 102, thus creating a tighter seal and preventing the sudden disassembly and ejection of the internal working valve components from the open end 152 of the barrel leg 134. The external threads 162 can be, for example, buttress threads configured to provide additional axial strength.

The body 102 additionally includes a fillet 164 on the outside of the acute angle between the barrel leg 134 and the outlet portion 130 or central portion 132, which is a known weak point in y-body designs. Accordingly, the fillet 164 provides additional structural strength by reducing the stress concentration at that location.

The body 102 also includes first and second bosses 166a, 166b on the exterior of the inlet port 128 and the central portion 132, respectively. Accordingly, the first bosses 166a, 166b are positioned on opposite sides of the barrel leg 134. The first and second bosses 166a, 166b can be drilled through or tapped, thus permitting the addition of a threaded port, e.g., a ¼″ NPT thread port, and a pressure sensing device, e.g., a pressure gauge, a pressure transducer, a manometer, etc., a flow sensing device, a valve, or other device, can be installed in the resulting hole/port of each boss 166a, 166b, if desired. Thus, a first pressure sensing device can be installed within the first boss 166a to measure the pressure within the inlet flow chamber 138 upstream of the barrel leg 134 (and the valve components installed in the barrel leg 134) and a second pressure sensing device can be installed within the second boss 166b to measure the pressure within the central flow chamber 144 or the outlet flow chamber 142 downstream of the barrel leg 134 (and the valve components installed in the barrel leg 134). Accordingly, the first and second pressure sensing devices can be used to measure differential pressure across the Y-check valve 100. It should be understood that other gauges, sensors, etc., can be installed in the first and second bosses 166a, 166b in place of the first and second pressure sensing devices.

The body 102 can be fabricated from a thermoplastic, for example, polyvinyl chloride (PVC), chlorinated polyvinyl chloride (CPVC), polyethylene (PE), polyvinylidene fluoride (PVDF), polypropylene (PP), and the like, using an injection molding process.

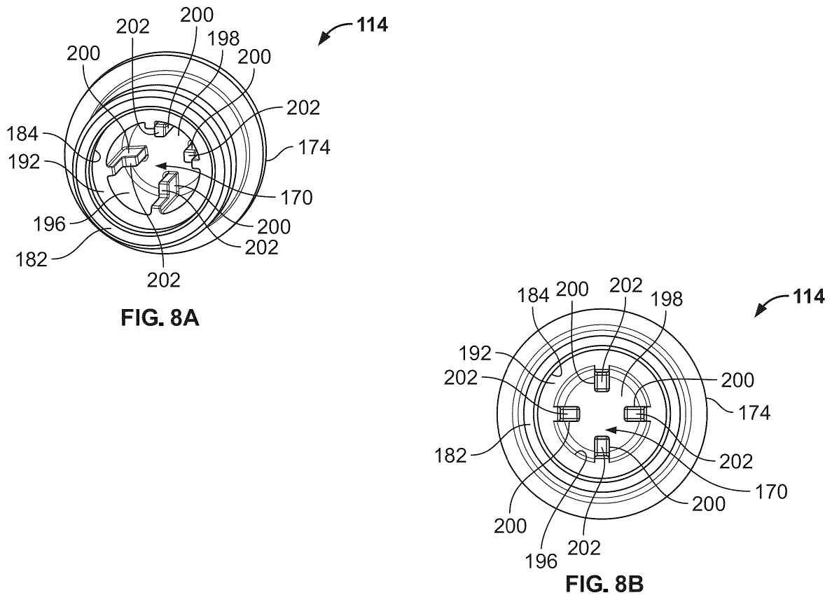

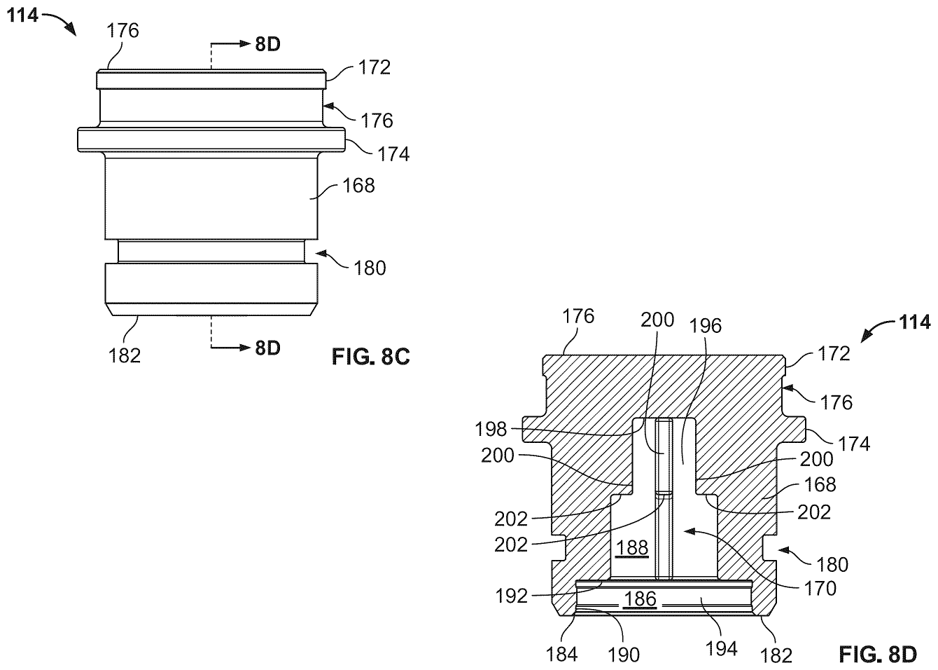

With reference to FIGS. 8A-8D, the retainer 114 includes a generally cylindrical unitary body 168 that defines an internal chamber 170. The retainer 114 includes first and second annular shoulders 172, 174 defining an annular channel 176 there between, which is configured to receive a portion of the barrel nut 116, as discussed in connection with FIGS. 10A-10C. The first annular shoulder 172 can include a chamfered upper edge 176, which facilitates insertion of the first annular shoulder 172 into the barrel nut 116 and forcing of the barrel nut 116 over the first annular shoulder 172. The second annular shoulder 174 is configured to rest on the open end 152 of the barrel leg 134 of the body 102 when the retainer 114 is inserted into the barrel leg 134. The retainer 114 additionally includes a circumferential channel 180 that extends into the exterior of the body 168. The circumferential channel 180 is configured to receive and house the retainer seal 122, which can be an o-ring or other gasket. The retainer seal 122 is generally compressed within the circumferential channel 180 between the body 168 of the retainer 114 and the inner surface of the second bore 158b of the barrel leg 134 when the retainer 114 is inserted into the barrel leg 134, and isolates the distal end of the barrel leg 134, e.g., the open end 152, from pressure within the barrel leg 134.

The retainer 114 includes an open end 182 defining an opening 184 in communication with the internal chamber 170. The internal chamber 170 is defined by a first bore 186 and a counter-bore 188. The first bore 186 is positioned immediately adjacent the opening 184 and is defined by a first inner cylindrical wall 190 and an internal radial shoulder 192. The first inner cylindrical wall 190 includes an annular ridge 194 extending radially inward therefrom, e.g., into the internal chamber 170. The annular ridge 194 is designed to removably engage the retainer end cap 108 and secure the cage subassembly 124 to the retainer 114 by way of a snap-fit connection, which is discussed in greater detail in connection with FIGS. 17A-17C. The internal radial shoulder 192 is configured to prevent further insertion of the retainer end cap 108 into the internal chamber 170 of the retainer 114 and thus ensures proper placement thereof.

The counter-bore 188 has a smaller diameter than the first bore 186 and is defined by a second inner cylindrical wall 196 and an end wall 198. The retainer 114 includes a plurality of internal stepped ribs 200 that extend radially inward from the second inner cylindrical wall 196 and into the counter-bore 188. The stepped ribs 200 span the length of the counter-bore 188, e.g., from the internal radial shoulder 192 to the end wall 198, and each include an intermediate shoulder 202. The intermediate shoulders 202 are configured to engage the spring 112 and provide a surface against which the spring 112 can be compressed. The intermediate shoulders 202 are located at a position along the stepped ribs 200, e.g., at a particular distance from the inner portion of the end wall 198, to ensure that the spring 112 maintains a bias on the disc 110 and the disc seal 120 when the Y-check valve 100 is in a first position, e.g., a closed position. The portions of the stepped ribs 200 between the internal radial shoulders 192 and the intermediate shoulders 202 are configured to engage the spring 112 about its outer diameter, e.g., the exterior surface of the spring 112, so as to prevent lateral displacement of the spring 112 and thus guide axial compression of the spring 112.

It is additionally noted that the end wall 198 can be of sufficient thickness to allow for full tapping thereof thus permitting the addition of a threaded port, e.g., a ¼″ NPT thread port. Accordingly, a user can add a threaded port, e.g., a ¼″ NPT thread port, through the end wall 198 and install a blowout port (e.g., pressure relief port) or a pressure sensing device, e.g., a pressure gauge, a pressure transducer, a manometer, etc., therein.

Accordingly, the retainer 114 functions to accept the retainer seal 122, provide a sealing surface for the retainer seal 122, properly locate the retainer seal 122 on the inner surface of the second bore 158b of the barrel leg 134 when inserted into the barrel leg 134, and provide functional structure to bias the spring 112 and retain the cage subassembly 124 and the spring 112.

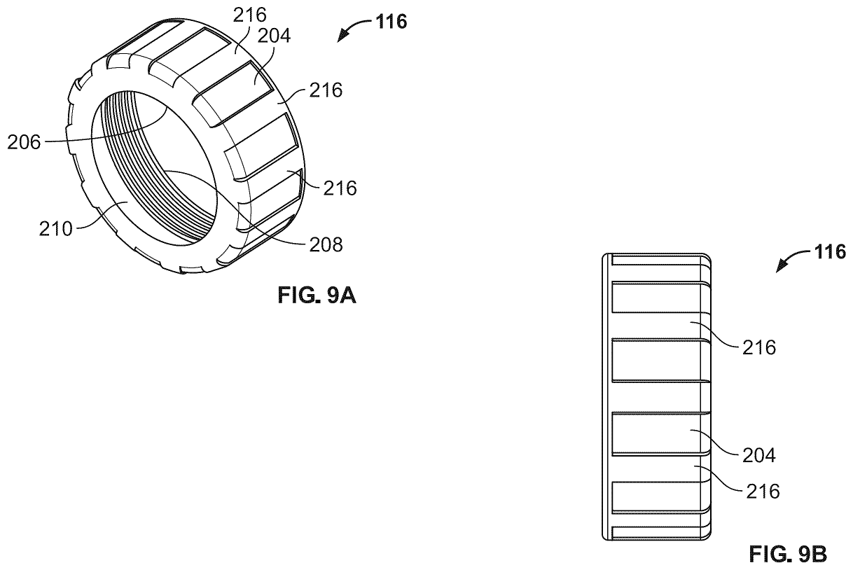

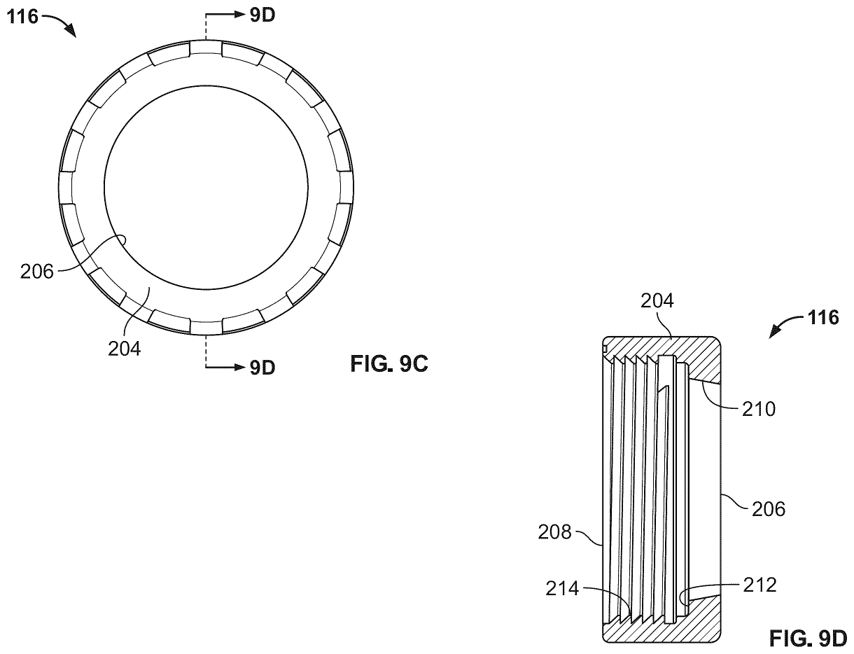

The barrel nut 116, which is shown in greater detail in FIGS. 9A-9D, includes an annular body 204 having a top opening 206 and a bottom opening 208. The top opening 206 is formed by a bore having an internal chamfered wall 210 that extends from the top opening 206 to an internal shoulder 212. The chamfered wall 210 angles radially outward from the top opening 206 to the internal shoulder 212 creating a cam surface. The top opening 206 and chamfered wall 210 allow the barrel nut 116 to be pressed onto the retainer 114 and permanently secured thereto, as shown in FIGS. 10A-10B, which illustrate the retainer-barrel nut subassembly 125. In particular, the barrel nut 116 can be placed over the retainer 114 such that the chamfered wall 210 surrounds and engages the first annular shoulder 172 of the retainer 114. Pressure can be applied to the barrel nut 116 and the retainer 114 to cause the first annular shoulder 172 to continue to progress along the chamfered wall 210, which acts as a cam ramp, and towards the top opening 206 until the chamfered wall 210 snaps over the first annular shoulder 172 and into annular channel 176 of the retainer 114. The second annular shoulder 174 of the retainer 114 engages the internal shoulder 212 of the barrel nut 116 and prevents the retainer 114 from being pulled through the top opening 206 of the barrel nut 116, while the first annular shoulder 172 prevents the barrel nut 116 from being disconnected from the retainer 114. Accordingly, the chamfered wall 210 is retained in the annular channel 176 and the barrel nut 116 is permanently attached to the retainer 114. When the barrel nut 116 is attached to the retainer 114, and the retainer-barrel nut subassembly 125 is formed, the chamfered wall 210 is permitted to rotate freely within the annular channel 176 such that the barrel nut 116 can rotate freely about the retainer 114.

The barrel nut 116 additionally includes internal threads 214 that are configured to engage the external threads 162 of the barrel leg 134 to assemble the Y-check valve 100 and secure the working valve components, e.g., the disc seal end cap 104, cage 106, retainer end cap 108, disc 110, spring 112, retainer 114, and seals 118, 120, 122, within the barrel leg 134. As previously noted, when there is a surge in pressure in the body 102, the external threads 162 of the barrel leg 134 can expand into the internal threads 214 of the barrel nut 116, thus creating a tighter seal and preventing the sudden disassembly and ejection of the internal working valve components from the open end 152 of the barrel leg 134. The internal threads 214 can be, for example, buttress threads configured to provide additional axial strength. Additionally, the exterior surface of the barrel nut 116 can include ribs 216 that provide added strength and a better grip surface for assembly and maintenance.

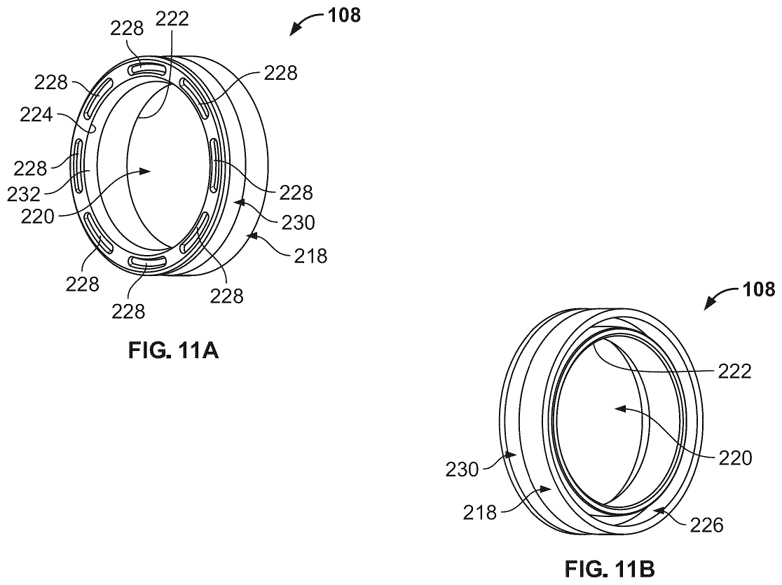

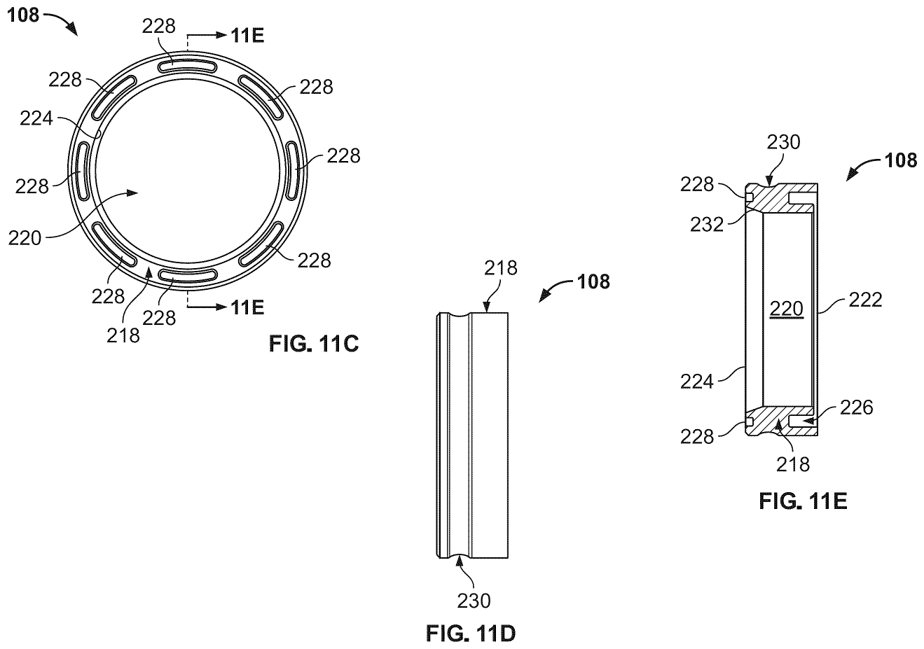

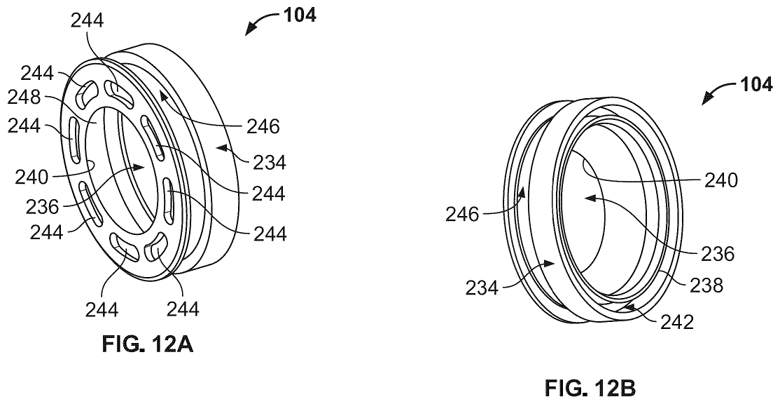

With reference to FIGS. 11A-11E, the retainer end cap 108 includes an annular body 218 defining a central cavity 220 that extends between a first opening 222 and a second opening 224. The annular body 218 includes an annular pocket 226 that is disposed in a bottom surface of the annular body 218 surrounding the first opening 222. The annular pocket 226 receives a portion of the cage 106, which is discussed in connection with FIGS. 14A and 14B. The annular body 218 also includes a plurality of radially spaced pockets 228 that are disposed in a top flat surface of the retainer end cap 108 and radially spaced about the second opening 224. The plurality of pockets 228 allow for tools to spin weld the retainer end cap 108 to the cage 106 when the cage 106 is inserted into the annular pocket 226. The plurality of pockets 228 allow for an improved welding connection. The annular body 218 of the retainer end cap 108 includes an exterior circumferential indentation 230, which is configured to receive and engage the annular ridge 194 of the retainer 114 to removably secure the cage subassembly 124 to the retainer 114 by way of a snap-fit connection.

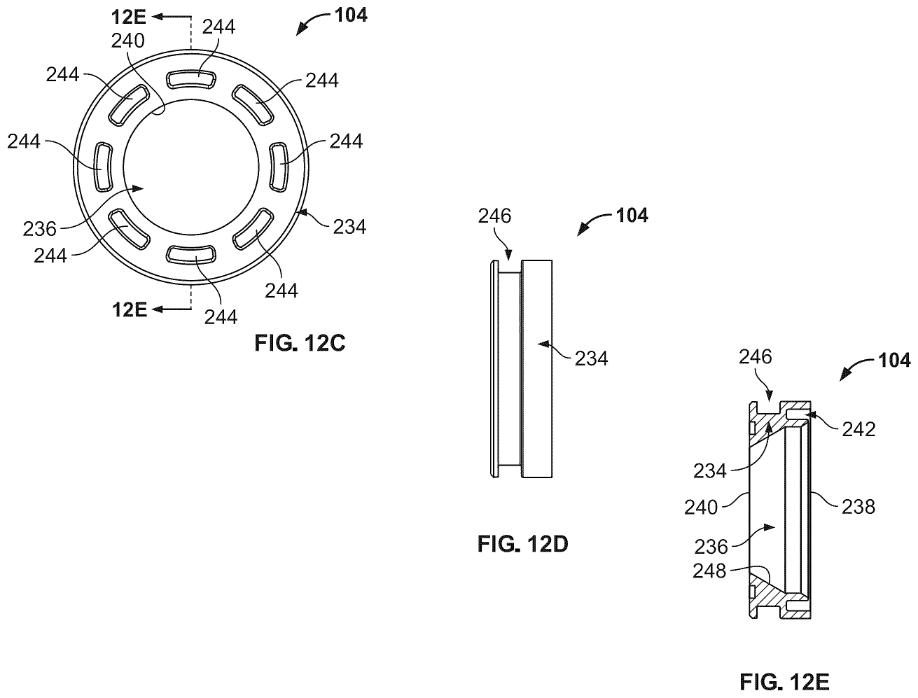

Accordingly, the retainer end cap 108 is configured to snap into and out of engagement with the retainer 114 using the exterior circumferential indentation 230 for assembly and maintenance with case and without tools. It is additionally noted that the retainer end cap 108 and the retainer 114 can be connected by other means, such as via threads, a twist lock connection, a lug and groove connection, a pressure-fit connection, or other mechanical engagement means. For example, the exterior circumferential indentation 230 of the retainer end cap 108 can be sized and shaped such that it can receive a gasket 231 (see FIG. 17D), e.g., the exterior circumferential indentation 230 can be provided as an exterior circumferential channel 233 (see FIG. 17D) similar to the exterior circumferential channel 246 of the disc seal end cap 104 (see FIGS. 12A-12E). In this configuration, the retainer end cap 108 could sealingly engage the retainer 114 and be secured thereto with a pressure-fit arrangement, e.g., with a gasket 231 positioned within the exterior circumferential channel 233 and compressed between the first inner cylindrical wall 190 of the retainer 114 and the retainer end cap 108, as shown in FIG. 17D. The annular body 218 can also include an internal chamfer 232 adjacent the second opening 224, which can assist with insertion of the disc 110 and spring 112 into and through the central cavity 220. In this regard, the first opening 222, second opening 224, and central cavity 220 are sized to allow the disc 110 and the spring 112 to freely pass therethrough and operate, e.g., without impeding motion of the disc 110 and the spring 112.

FIGS. 12A-12E illustrate the disc seal end cap 104 in greater detail. The disc seal end cap 104 includes an annular body 234 defining a central cavity 236 that extends between a first opening 238 and a second opening 240. The annular body 234 includes an annular pocket 242 that is disposed in a bottom surface of the annular body 234 surrounding the first opening 238, The annular pocket 242 receives a portion of the cage 106, which is discussed in connection with FIGS. 14A and 14B. The annular body 234 also includes a plurality of radially spaced pockets 244 that are disposed in a top flat surface of the disc seal end cap 104 and radially spaced about the second opening 240. The plurality of pockets 244 allow for tools to spin weld the disc seal end cap 104 to the cage 106 when the cage 106 is inserted into the annular pocket 242. The annular body 234 of the disc seal end cap 104 includes an exterior circumferential channel 246 that extends into the exterior of the annular body 234. The exterior circumferential channel 246 is configured to receive and house the cage seal 118, which can be an o-ring or other gasket. The cage seal 118 is generally compressed within the exterior circumferential channel 246 between the annular body 234 of the disc seal end cap 104 and the inner surface of the fourth bore 158d of the barrel leg 134 when the disc seal end cap 104 is inserted into the barrel leg 134, thus sealing the disc seal end cap 104 with the fourth bore 158d of the barrel leg 134. Accordingly, the disc seal end cap 104 functions to provide a sealing surface for the cage seal 118. It is additionally noted that in some aspects, the exterior circumferential channel 246 can be provided as a circumferential indentation, such as the circumferential indentation 230 of the retainer end cap 108, so that the disc seal end cap 104 can connect to the retainer 114 in a snap-fit engagement and be used in place of the retainer end cap 108. The annular body 234 also includes an internal chamfer 248 adjacent the second opening 240, which provides a sealing surface for the disc seal 120 to be compressed against by the disc 110 and seal against when the Y-check valve 100 is in the first, e.g., closed, position. Accordingly, the disc seal end cap 104 functions to provide a sealing surface for the disc seal 120. Additionally, the first opening 238, second opening 240, and central cavity 236 can be sized to provide increased flow compared to prior art Y-check valves.

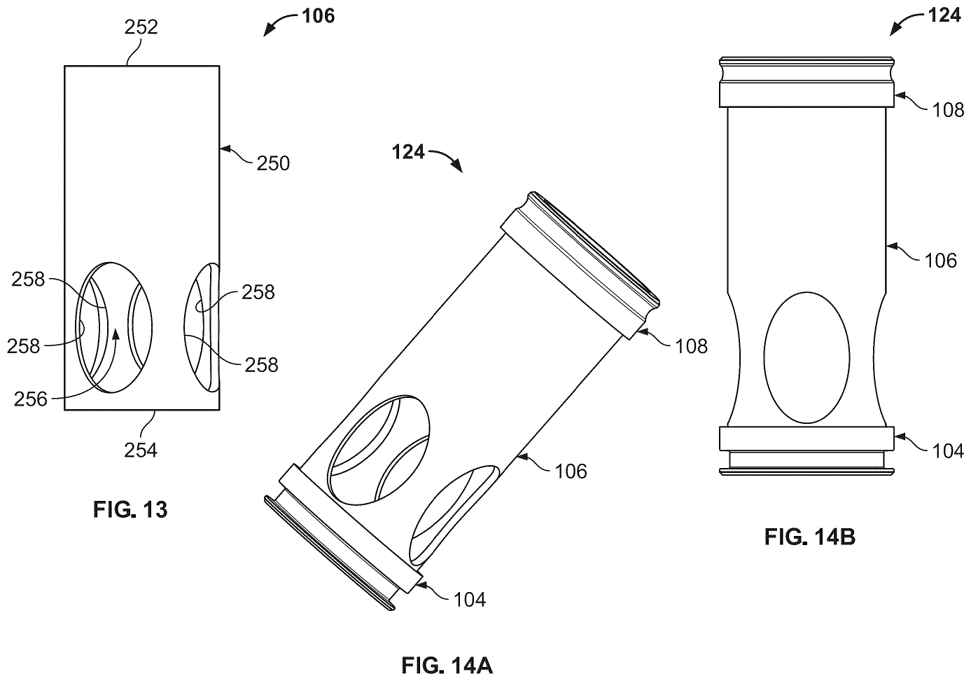

The cage 106 is shown in greater detail in FIG. 13. The cage 106 includes a hollow cylindrical body 250 that extends between an open first end 252 and an open second end 254, and defines a central chamber 256. The open first end 252 and open second end 254 are in fluidic communication by way of the central chamber 256. The cage 106 additionally includes a plurality of flow openings 258 that allow for fluid to freely enter and exit the central chamber 256 such that the cage 106 does not inhibit the flow of fluid through the Y-check valve 100 when the Y-check valve 100 is in the second position, e.g., open position.

As previously noted in connection with FIGS. 11A-11E and 12A-12E, the retainer end cap 108 and the disc seal end cap 104 are configured to be connected to the cage 106 through a spin welding process in order to form a cage subassembly 124, which is shown in FIGS. 14A and 14B. In this regard, the first end 252 of the cage 106 can be inserted into the annular pocket 226 of the retainer end cap 108 while the second end 254 of the cage 106 can be inserted into the annular pocket 242 of the disc seal end cap 104, and the radially spaced pockets 228, 244 can be utilized to spin weld the retainer end cap 108 and the disc seal end cap 104 to the cage 106. It is additionally noted that the retainer end cap 108 and the disc seal end cap 104 can be connected to the cage 106 by methods other than spin welding, e.g., via solvent cement, a threaded connection, ultrasonic welding, or other mechanical attachment means. The cage subassembly 124 functions to provide a seal surface for the disc seal 120, e.g., the internal chamfer 248 of the disc seal end cap 104, at the proper location when the Y-check valve 100 is in the first position, e.g., the closed position, and allows for the cage seal 118 to provide a seal at all times, e.g., with the disc seal end cap 104 and the inner surface of the fourth bore 158d of the barrel leg 134. The cage subassembly 124 additionally houses the disc 110 and spring 112 when the valve insert subassembly 126 is assembled, and ensures proper placement of the disc 110 and spring 112. In particular, the cage subassembly 124 ensures that the disc 110 and spring 112 always move in the proper direction, and that the disc 110 is retained at and properly seals with the disc seal end cap 104 when the Y-check valve 100 is in the first position.

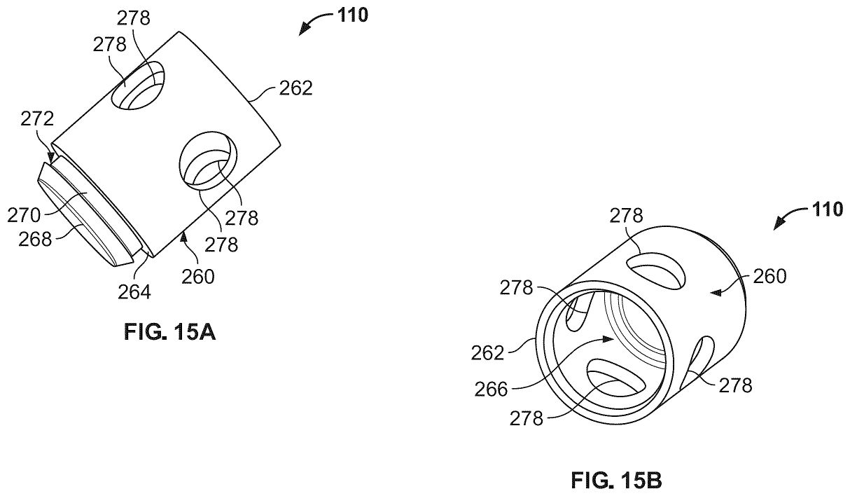

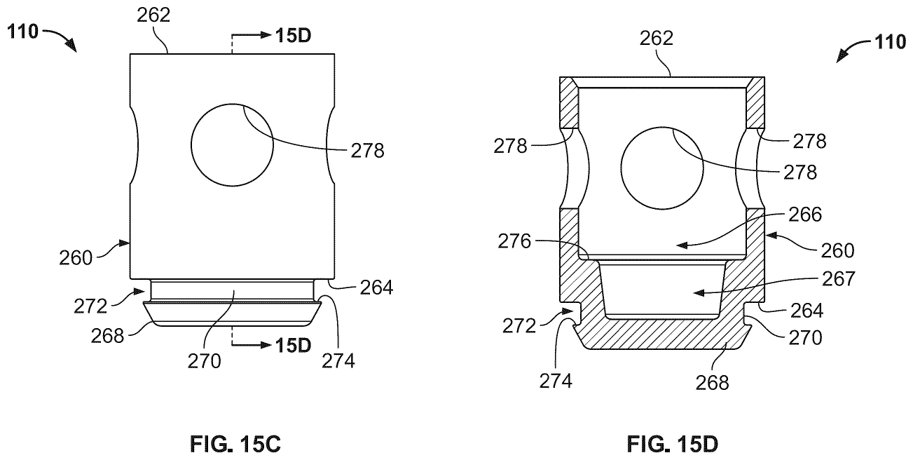

With reference to FIGS. 15A-15D, the disc 110 includes a cylindrical body 260 that extends between an open end 262 and a closed end 264, and defines an internal chamber 266 that receives a portion of the spring 112. The disc 110 also defines an internal cup 267 that can receive fluid when the Y-check valve 100 is closed and enhance the seal generated by the disc 110, which is discussed in greater detail below. A frustoconical head 268 is connected to the closed end 264 by a neck 270 forming a circumferential groove 272 between the closed end 264 and the head 268. The circumferential groove 272 receives the disc seal 120, which is configured to be compressed within the circumferential groove 272 between the neck 270 and the internal chamfer 248 of the annular body 234 of the disc seal end cap 104 when the Y-check valve 100 is in the first position, e.g., the closed position. In this regard, the frustoconical head 268 is sized and shaped to be inserted within the internal chamfer 248 so as to not impede sealing of the disc seal 120 with the internal chamfer 248.

Additionally, the groove 272 is designed so that the disc seal 120, which can be an o-ring or other gasket, is sufficiently recessed therein and protected by the closed end 264, which forms an upper wall that overhangs the groove 272 and disc seal 120, and a lower lip 274 that is formed by the head 268. When fluid is flowing through the Y-check valve 100 in a forward direction, the lower lip 274 deflects flow around the disc 110 and the disc seal 120, while the closed end 264, which overhangs the groove 272, retains the disc seal 120 and prevents the disc seal 120 from being dislodged. When the flow of fluid through the Y-check valve 100 is stopped and then reversed, e.g., while the Y-check valve 100 is in the process of “checking” the backflow of fluid in the piping system, the lower lip 274 prevents the disc seal 120 from being pulled out, or dislodged, from the groove 272 by differential pressure and/or flowing fluid.

The disc 110 includes an internal shoulder 276 that extends radially inward into the chamber 266. The internal shoulder 276 provides a surface that the spring 112 can engage and contact, and against which the spring 112 can be compressed. Accordingly, the spring 112 is compressible between the internal shoulder 276 of the disc 110 and the intermediate shoulders 202 of the retainer 114. The disc 110 additionally includes a plurality of flow openings 278 that allow for fluid to freely enter and exit the internal chamber 266 such that the disc 110 does not inhibit the flow of fluid through the Y-check valve 100 when the Y-check valve 100 is in the second position. The disc 110 is sized to fit within the cage subassembly 124 and freely move therein without impediment to operation.

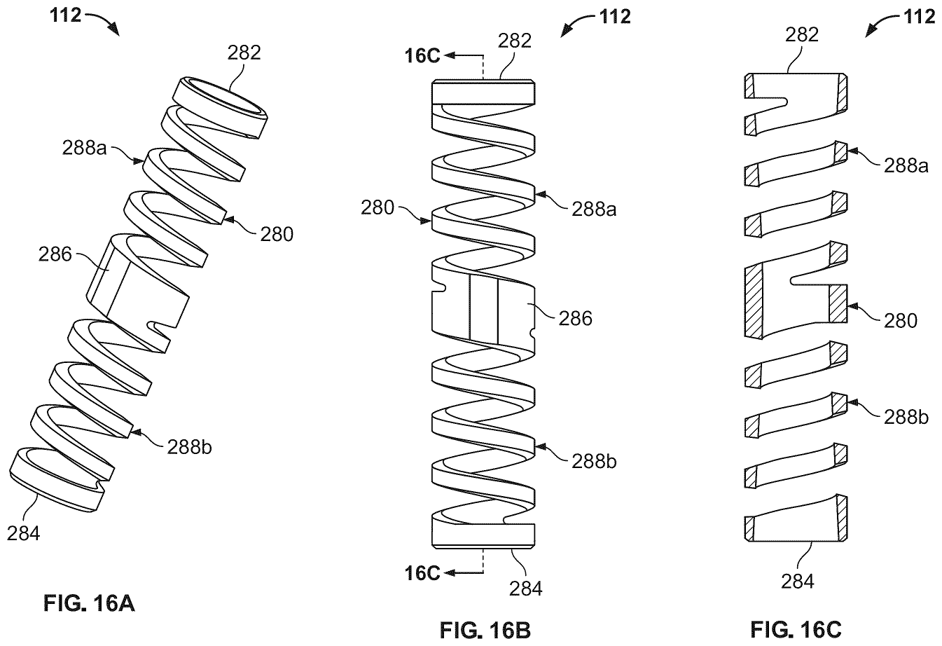

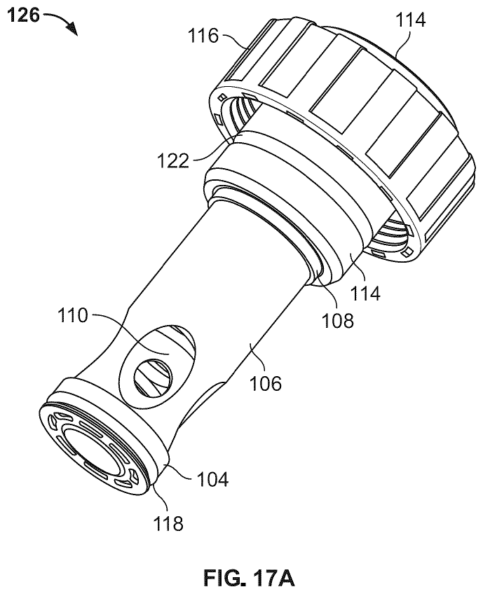

Turning to FIGS. 16A-16C, the spring 112 includes a coiled body 280 that extends from a first end 282 to a second end 284. The spring 112 is a linear compression spring that is injection molded. In this regard, the spring 112 can be injection molded with a center gate 286 and two spring portions 288a, 288b extending outward from the center gate 286 to the first and second ends 282, 284, respectively. The spring 112 is configured to be positioned and retained between the retainer 114 and the disc 110 with the first end 282 of the spring 112 engaging the intermediate shoulders 202 of the retainer 114 and the second end 284 of the spring 112 engaging the internal shoulder 276 of the disc 110. However, the spring 112 can be reversible such that there is no distinction between the first and second ends 282, 284. The spring 112 functions to provide a bias on the disc 110 and the disc seal 120 so that the disc seal 120 seals against the internal chamfer 248 of the disc seal end cap 104 and prevents back flow through the Y-check valve 100 when in the first position, e.g., when fluid is not flowing through the Y-check valve 100 in the forward direction. The spring 112 can also be compressed so that fluid can break the seal formed between the disc seal 120 and the internal chamfer 248 of the disc seal end cap 104 when fluid pressure in the piping system is increased, thus allowing fluid to flow freely through the Y-check valve 100 from the inlet port 128 to the outlet port 130 through the inlet flow chamber 138, central flow chamber 144, and outlet flow chamber 142. That is, when fluid pressure in the piping system upstream of the Y-check valve 100 is increased, such fluid pressure is applied to the disc 110, which transfers the force to the spring 112 causing the spring 112 to compress, which is shown, for example, in FIG. 18B.

The spring 112, e.g., the coiled body 280 of the spring 112, is formed with a trapezoidal cross-section, as shown in FIG. 16C, which not only allows for the spring 112 to more easily compress, but also assists with the injection molding process. In particular, the trapezoidal cross-section is more easily moldable, allows for the two halves of the injection mold to more easily release after injection molding, and is more accommodating of the pull angle required by the tool for removing the spring 112 from the mold after injection molding. However, it should be understood that the spring 112 can be formed with a different shaped cross-section, e.g., square, round, etc., a variable cross-section, e.g., a trapezoidal cross-section that reduces in size from the center gate 286 to the first and second ends 282, 284, or even a cross-section that morphs or changes shape along the length of the spring 112, e.g., from a trapezoidal cross-section adjacent the center gate 286 to a square cross-section at the first and second ends 282, 284. Furthermore, the spring 112 can be formed with a constant (e.g., straight) inner diameter, constant (e.g., straight) outer diameter, variable (e.g., tapered) inner diameter, and/or variable (e.g., tapered) outer diameter. The first and second spring portions 288a, 288b can be formed with the same or different cross-sections, outer diameters, inner diameters, outer profile, inner profile, lengths, etc.

As previously noted, the spring 112 includes a center gate 286, which is the location at which material is injected into the mold during the injection molding process of forming the spring 112. Positioning the gate 286 at the center of the spring 112, as opposed to the end of the spring 112, has several advantages. First, the distance in which material must travel in order to form the spring 112 is halved, which allows for a more consistent cross-section to be formed and also allows for a longer spring 112 to be formed as there are essentially two springs that are connected by the center gate 286. In contrast, if an end gate were used to mold the spring 112, e.g., from either the first or second ends 282, 284, the ability to flow material from one end to the other would be diminished along the length of the cross-section resulting in a shorter spring or a spring that reduces in coil cross-section along the length thereof. However, an end gate could be utilized for the spring 112, but a variably decreasing cross-section would be implemented to provide a suitable flow path for injection molded thermoplastic material and for best results. Additionally, the center gate 286 allows for the spring 112 to be formed with the two spring portions 288a, 288b, which can have different characteristics, e.g., different cross-sections, outer diameters, inner diameters, outer profile, inner profile, lengths, etc.

Moreover, the spring 112 can be formed of polyvinylidene fluoride (PVDF), which is not only more moldable than some other thermoplastics, but can also handle high temperatures and aggressive chemicals.

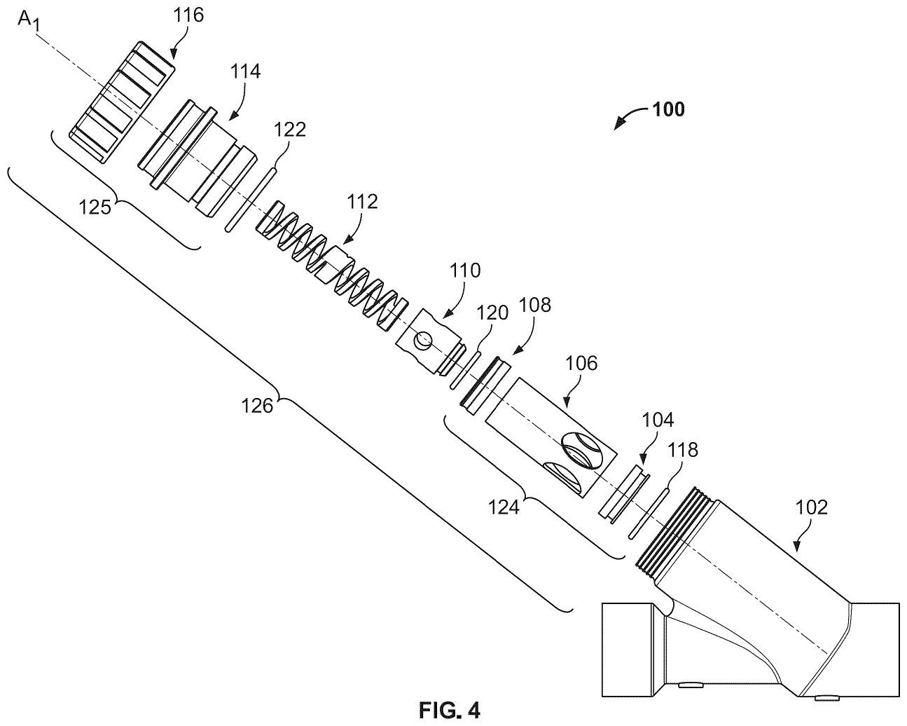

The Y-check valve 100 is assembled by first assembling the valve insert subassembly 126, which is shown in greater detail in FIGS. 17A-17B and in the exploded view of FIG. 4. In particular, first the cage subassembly 124 is formed by inserting the first end 252 of the cage 106 into the annular pocket 226 of the retainer end cap 108, affixing the retainer end cap 108 to the cage 106 (e.g., by spin welding), inserting the second end 254 of the cage 106 into the annular pocket 242 of the disc seal end cap 104, and affixing the disc seal end cap 104 to the cage 106 (e.g., by spin welding). Next, the cage seal 118 is installed in the exterior circumferential channel 246 of the disc seal end cap 104 and the disc seal 120 is installed in the circumferential groove 272 of the disc 110. The spring 112 is then inserted into the disc 110 through the open end 262 thereof, and the disc 110 and spring 112 combination are inserted into the cage subassembly 124 through the second opening 224 of the retainer end cap 108. Next, the retainer-barrel nut subassembly 125 (see FIGS. 10A-10C) is formed by engaging the retainer 114 and the barrel nut 116. In particular, the barrel nut 116 can be placed over the retainer 114 such that the chamfered wall 210 surrounds and engages the first annular shoulder 172 of the retainer 114. Pressure can be continuously applied to the barrel nut 116 and the retainer 114 to cause the first annular shoulder 172 to continue to progress along the chamfered wall 210, which acts as a cam ramp, and towards the top opening 206 until the chamfered wall 210 snaps over the first annular shoulder 172 and into the annular channel 176 of the retainer 114 where it is retained. The retainer seal 122 is then installed in the circumferential channel 180 of the retainer 114. When the barrel nut 116 is attached to the retainer 114, and the retainer-barrel nut subassembly 125 is formed, the chamfered wall 210 is permitted to rotate freely within the annular channel 176 such that the barrel nut 116 can rotate freely about the retainer 114.

The cage subassembly 124, with disc 110 and spring 112 positioned therein, is then snapped into connection with the retainer-barrel nut subassembly 125. In particular, the first end 282 of the spring 112 is inserted into the opening 184 of the retainer 114 until it contacts the intermediate shoulder 202 thereof, and then force is applied to the cage subassembly 124 to insert the retainer end cap 108 into the opening 184 of the retainer 114 and force the retainer end cap 108 over the annular ridge 194 of the retainer 114 until the retainer end cap 108 engages the internal radial shoulder 192 of the retainer 114 with the annular ridge 194 engaged with the exterior circumferential indentation 230 of the retainer end cap 108, as shown in FIG. 17C. Alternatively, the retainer end cap 108 and the retainer 114 can be connected by other means, such as via threads, a twist lock connection, a lug and groove connection, a pressure-fit connection, or other mechanical engagement means, as previously noted. For example, as shown in FIG. 17D, the retainer end cap 108 can include an exterior circumferential channel 233 that can receive a gasket 231. In this configuration, the retainer end cap 108 could sealingly engage the retainer 114 and be secured thereto with a pressure-fit arrangement, e.g., with the gasket 231 positioned within the exterior circumferential channel 233 and compressed between the first inner cylindrical wall 190 of the retainer 114 and the retainer end cap 108.

The valve insert subassembly 126 is then inserted into the central chamber 156 of the barrel leg 134 through the opening 154. The barrel nut 116, which is free to rotate about the retainer 114, is then threaded engaged with the external threads 162 on the open end 152 of the barrel leg 134. Continued rotation of the barrel nut 116 is performed to cause the valve insert subassembly 126 to be further inserted into the barrel leg 134 until the bottom of the second annular shoulder 174 contacts the open end 152 of the barrel leg 134 and the disc seal end cap 104 is fully seated in the fourth bore 158d of the barrel leg 134. In this regard, since the bottom of the second annular shoulder 174 contacts the open end 152 of the barrel leg 134, the thickness of the second annular shoulder 174 and location thereof on the retainer 114 controls the seating and placement of the Y-check valve 100 components within the barrel leg 134. That is, the thickness and placement of the second annular shoulder 174 controls how deep into the barrel leg 134 the Y-check valve 100 components, e.g., the disc seal end cap 104, the cage 106, the retainer end cap 108, the disc 110, the spring 112, the retainer 114, the cage seal 118, the disc seal 120, and the retainer seal 122, are driven, as well as the placement of those components within the barrel leg 134. Moreover, since the barrel nut 116 is permitted to rotate freely about the retainer 114, the disc seal end cap 104, the cage 106, the retainer end cap 108, the disc 110, the spring 112, the retainer 114, the cage seal 118, the disc seal 120, and the retainer seal 122 do not rotate with the barrel nut 116 and therefore are driven into the barrel leg 134 without rotating during assembly of the Y-check valve 100, which maintains the integrity of the cage seal 118 and the retainer seal 122.

The resulting fully assembled Y-check valve 100 is shown in FIG. 18A, which is a sectional view of the Y-check valve 100 of FIGS. 1-4 taken along line 18A-18A of FIG. 3 showing the Y-check valve 100 in the first position, e.g., the closed position. As can be seen in FIG. 18A, when the Y-check valve 100 is fully assembled and in the first position, the cage seal 118 is compressed and creates a seal between the disc seal end cap 104 and the inner surface of the fourth bore 158d of the barrel leg 134, the retainer seal 122 is compressed and creates a seal between the body 168 of the retainer 114 and the inner surface of the second bore 158b of the barrel leg 134, and the disc seal 120 is compressed and creates a seal between the internal chamfer 248 of the disc seal end cap 104 and the disc 110. The Y-check valve 100 can then be installed in a piping system of the designated size. Generally, when the Y-check valve 100 is installed in the piping system, the barrel leg 134 of the body 102 should be installed in the up position, e.g., above the piping. Moreover, if the Y-check valve 100 includes true union end connections, such as in FIG. 6, then an o-ring or other gasket can be installed in the front face 148 of each of the inlet and outlet ports 128, 130 prior to installation and true union nuts can be engaged with the threads 146 of the inlet and outlet ports 128, 130 of the body 102 to install the Y-check valve 100 in the piping system.

FIG. 18A illustrates the Y-check valve 100 in a first, e.g., closed, position while FIG. 18B illustrates the Y-check valve 100 in a second, e.g., open, position, for example, when the Y-check valve 100 is installed in a piping system and fluid is flowing into the inlet port 128 of the body 102. As can be seen in FIG. 18A, when the Y-check valve 10 is fully assembled and in the first position, e.g., the closed position, the spring 112 forces the disc 110 toward the disc seal end cap 104 causing the disc seal 120 to be compressed between the internal chamfer 248 of the disc seal end cap 104 and the disc 110, which results in the creation of a seal between the disc 110 and the disc seal end cap 104. Additionally, as noted, a seal is also formed between the disc seal end cap 104 and the fourth bore 158d of the barrel leg 134 by way of the cage seal 118, which is compressed and creates a seal between the disc seal end cap 104 and the inner surface of the fourth bore 158d of the barrel leg 134. Accordingly, when the Y-check valve 100 is in the first position, fluid is prevented from flowing in the reverse direction therethrough. That is, the fourth bore 158d of the barrel leg 134, the disc seal end cap 104, the disc 110, the cage seal 118, and the disc seal 120, along with the seals created therebetween, also prevent fluid from flowing from the outlet port 130 of the body 102 to the inlet port 128, e.g., any fluid that in the outlet flow chamber 142 or the central flow chamber 144 is prevented from flowing into the inlet flow chamber 138. It is also noted that any fluid pressure downstream of the Y-check valve 100 would enhance the seal between the disc seal end cap 104, disc 110, and disc seal 120, as such pressure would force the disc 110 to further seat into the disc seal end cap 104 and compress the disc seal 120. In particular, fluid can enter the internal chamber 266 defined by the disc 110 and impart force on the internal cup 267, which forces the disc to further seat into the disc seal end cap 104 and compress the disc seal 120. Additionally, the fourth bore 158d of the barrel leg 134, the disc seal end cap 104, the disc 110, the cage seal 118, and the disc seal 120, along with the seals created therebetween, prevent fluid of insufficient pressure from flowing from the inlet port 128 of the body 102 to the outlet port 130, e.g., through the inlet flow chamber 138 and into the central flow chamber 144 and the outlet flow chamber 142.

Once forward flow in the piping system is started, e.g., due to the activation of a pump in the piping system, fluid enters the Y-check valve 100 through the inlet opening 136 of the inlet port 128 of the body 102. The pressure and flow generated by the pump imparts a force F on the disc 110, as shown in FIG. 18B, which causes the disc 110 to open. In particular, the force F imparted on the disc 110 breaks the seal between the disc seal 120, the disc 110, and the disc seal end cap 104 and causes the spring 112 to compress, which results in the translation of the disc 110 along the axis of the barrel leg 134 toward the retainer 114. Compression of the spring 112 and translation of the disc 110 results in the opening of the second opening 240 of the disc seal end cap 104 thus allowing fluid to flow through the disc seal end cap 104, past the disc 110, and into the central chamber 256 of the cage 106. The fluid fills the central chamber 156 of the barrel leg 134, and flows out of the cage 106 through the flow openings 258 and into the central flow chamber 144. The fluid continues into the outlet flow chamber 142 and exits the Y-check valve 100 through the outlet opening 140 at which point it enters the external piping system to which the Y-check valve 100 is installed.

When the pump is shutdown, the fluid flow to the Y-check valve 100 is stopped or severely reduced, which results in the force F imparted on the disc 110 reducing in magnitude. In particular, the force F on the disc 110 reduces to a level that gravity and the spring bias of the spring 112 are able to overcome. Accordingly, the spring 112 overcomes the forward momentum of the fluid causing the disc 110 to close such that a seal is once again formed between the disc seal 120, the disc 110, and the disc seal end cap 104 as the disc seal 120 is compressed, which prevents the backflow of fluid through the Y-check valve 100. Fluid from the piping system downstream of the Y-check valve 100 fills the outlet flow chamber 142, the central flow chamber 144, and the central chamber 156 of the barrel leg 134, but does not leak into the inlet flow chamber 138. No additional fluid passes through the Y-check valve 100 until forward flow is resumed, e.g., upon activation of the pump.

Additionally, the Y-check valve 100 can be monitored using one or more pressure sensing devices, flow monitoring devices, etc., to ensure and confirm that the disc 110 has fully seated within the disc seal end cap 104 when the pump is shutdown, and, thus, has “checked” and stopped flow through the Y-check valve 100. In particular, the first boss 166a and/or the second boss 166b of the barrel leg 134 can be drilled through or tapped, and a device, e.g., a pressure sensing device, a flow monitoring device, or a valve, can be installed in the resulting hole/port of each boss 166a, 166b and monitored to confirm that the disc 110 has fully seated within the disc seal end cap 104 and is preventing backflow through the Y-check valve 100. For example, a pressure monitoring device or flow monitoring device can be installed in the tapped hole of the first boss 166a and monitor pressure upstream of the barrel leg 134 to confirm that the disc 110 has “checked” and stopped flow through the Y-check valve 100. Alternatively, a bleed valve, e.g., a ball valve, can be installed in the tapped hole of the first boss 166a, opened to bleed the pressure from the inlet flow chamber 138 of the Y-check valve 100 upstream of the barrel leg 134, and monitored to confirm that the disc 110 has fully seated within the disc seal end cap 104 and is preventing backflow through the Y-check valve 100.

Furthermore, when the Y-check valve 100 is installed in a piping system, a user may need to remove the valve insert subassembly 126 and replace the entire subassembly 126 or individual components thereof. To do so, a user can slowly unscrew or unfasten the barrel nut 116, which causes the barrel nut 116 to draw the entire valve insert subassembly 126 toward the open end 152 of the barrel leg 134, e.g., due to the permanent engagement between the barrel nut 116 and the retainer 114. This process is shown in FIG. 18C, which is a sectional view of the Y-check valve 100 showing the removal of components from the body 102 and the formation of a pressure relief passage 290.

As the valve insert subassembly 126 is pulled toward the open end 152 of the barrel leg 134 and backed-out, the retainer seal 122, which is a piston-type seal that is initially engaged with the wall of the second bore 158b, moves with the retainer 114 from the second bore 158b and into the first bore 158a traversing the second chamfer 160b, which has a larger diameter than the second bore 158b. Accordingly, the retainer seal 122 does not form a seal with the first bore 158a, as it did with the second bore 158b, which creates a small passage 290 between the retainer 114 and the wall of the first bore 158a of the barrel leg 134, as shown in FIG. 18C. Pressure can be relieved from the barrel leg 134 and the Y-check valve 100 along the foregoing passage 290 to prevent the valve insert subassembly 126 from being rapidly discharged from the barrel leg 134 during disassembly of the Y-check valve 100 and removal of the valve insert subassembly 126. Notably, the length of the threads 162 on the open end 152 of the barrel leg 134 and the internal threads 214 of the barrel nut 116 are longer than the distance between the retainer seal 122 and the second chamfer 160b when the valve insert subassembly 126 is fully inserted into the barrel leg 134 and installed. This geometry and these dimensions ensure that the barrel nut 116 remains engaged with the open end 152 of the barrel leg 134, e.g., due to the mating threads 162, 214, when the retainer seal 122 traverses the second chamfer 160b and the pressure relief passage 290 is formed, thus allowing the pressure to be relieved from the Y-check valve 100 while the barrel nut 116 is still engaged with the barrel leg 134 and ensuring the safety of the user. Once the pressure is fully relieved, the barrel nut 116 can be further rotated until it disengages the barrel leg 134 and the valve insert subassembly 126 can be removed from the barrel leg 134.

Alternatively, the retainer seal 122 can be positioned and sized such that it initially engages the wall of the first bore 158a, as opposed to the wall of the second bore 158b, and forms a seal between the first bore 158a and the retainer 114. In this configuration, the pressure relief passage 290 is formed between the retainer 114 and the wall of the first bore 158a of the barrel leg 134 or the first chamfer 160a at the open end 152 of the barrel leg 134 as the valve insert subassembly 126 is pulled toward the open end 152 of the barrel leg 134 and backed-out therefrom. In particular, in this configuration, the pressure relief passage 290 would be formed as the retainer seal 122 traverses the first chamfer 160a and exits the open end 152 of the barrel leg 134, e.g., as the retainer seal 122 is pulled to atmosphere. As the pressure relief passage 290 is formed, the internal threads 214 of the barrel nut 116 remain engaged with the threads 162 at the open end 152 of the barrel leg 134, thus allowing the pressure to be relieved from the Y-check valve 100 while the barrel nut 116 is still engaged with the barrel leg 134.

In another aspect, the first and second bores 158a, 158b could be combined into a single bore having the diameter of the second bore 158b. That is, the first bore 158a and the second chamfer 160b could be omitted such that the second bore 158b extends from the first chamfer 160a at the open end 152 of the barrel leg 134 to the third chamfer 160c. In this configuration, the pressure relief passage 290 is formed between the retainer 114 and the wall of the second bore 158b of the barrel leg 134 or the first chamfer 160a at the open end 152 of the barrel leg 134 as the valve insert subassembly 126 is pulled toward the open end 152 of the barrel leg 134 and backed-out therefrom, e.g., as the retainer seal 122 is pulled to atmosphere. In particular, in this configuration, the pressure relief passage 290 would be formed as the retainer seal 122 traverses the first chamfer 160a and exits the open end 152 of the barrel leg 134. As the pressure relief passage 290 is formed, the internal threads 214 of the barrel nut 116 remain engaged with the threads 162 at the open end 152 of the barrel leg 134, thus allowing the pressure to be relieved from the Y-check valve 100 while the barrel nut 116 is still engaged with the barrel leg 134.

In still another aspect, the retainer seal 122 could be provided as a face seal that is compressed between the open end 152 of the barrel leg 134 and the bottom of the second annular shoulder 174. In this configuration, the pressure relief passage 290 is formed between the retainer 114 and the open end 152 of the barrel leg 134 as the valve insert subassembly 126 is pulled toward the open end 152 of the barrel leg 134 and backed-out therefrom. In particular, in this configuration, the pressure relief passage 290 would be formed as soon as the barrel nut 116 is loosened and the seal between the retainer seal 122, the open end 152, and the annular shoulder 174 is broken. As the pressure relief passage 290 is formed, the internal threads 214 of the barrel nut 116 remain engaged with the threads 162 at the open end 152 of the barrel leg 134, thus allowing the pressure to be relieved from the Y-check valve 100 while the barrel nut 116 is still engaged with the barrel leg 134.

FIG. 19 is a perspective view of an exemplary integral spring and disc 300, which can be used with the Y-check valve 100. In this regard, the integral spring and disc 300 is essentially the disc 110 and the spring 112 provided as a single integral component, and can replace the disc 110 and the spring 112 of the Y-check valve 100. The integral spring and disc 300 includes a coiled spring body 302 extending from a first open end 304 to a second closed end 306, and a frustoconical head 308 connected to the second closed end 306 by a neck 310. The neck 310 forms a circumferential groove 312 between the closed end 306 and the head 308. The frustoconical head 308, neck 310, and circumferential groove 312 of the integral spring and disc 300 can be identical in construction and operation to the frustoconical head 268, neck 270, and circumferential groove 272 of the disc 110 discussed in connection with FIGS. 15A-D. In this regard, the circumferential groove 312 can receive the disc seal 120, which is configured to be compressed within the circumferential groove 312 between the neck 310 and the internal chamfer 248 of the disc seal end cap 104 when the Y-check valve 100 is in the first position, e.g., the closed position.

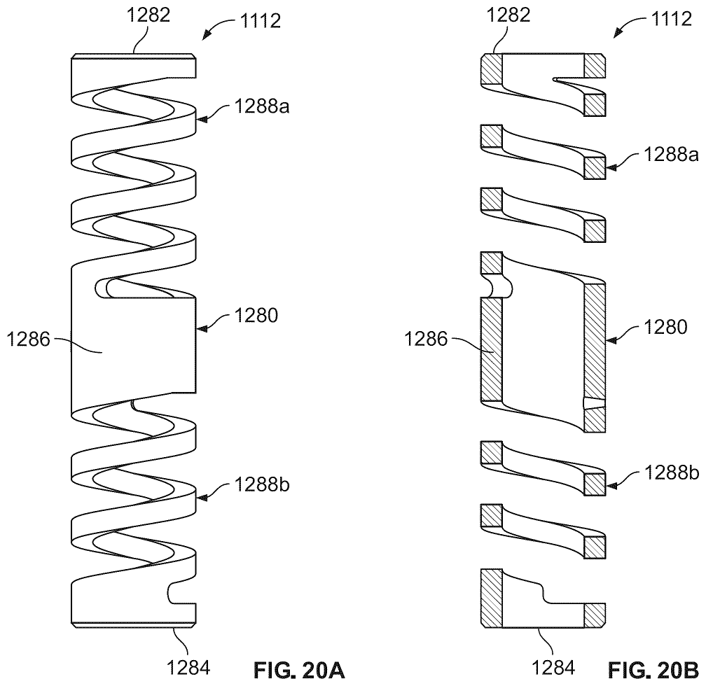

FIGS. 20A-25 illustrate alternative exemplary springs of the present disclosure that can be substantially similar to the spring 112 shown and described in connection with FIGS. 16A-C. Accordingly, in FIGS. 20A-25, like elements are referenced with like element numbers, but incremented by one-thousand for each exemplary spring.

FIG. 20A is a side view of a second exemplary spring 1112 and FIG. 20B is a sectional view of the second exemplary spring 1112. The second exemplary spring 1112 can be substantially similar to the spring 112 shown and described in connection with FIGS. 16A-C, but includes a uniform internal diameter, as opposed to the tapered internal diameter of spring 112, which increases in diameter from the center gate 286 to the first end 282 and to the second end 284, as well as square cross-section coils, as opposed to the trapezoidal cross-section coils of spring 112. Accordingly, the second exemplary spring 1112 includes a coiled body 1280 that extends from a first end 1282 to a second end 1284. The second exemplary spring 1112 is a linear compression spring that can be injection molded with a center gate 1286 and two spring portions 1288a, 1288b extending outward from the center gate 1286 to the first and second ends 1282, 1284, respectively. The internal diameter of the second exemplary spring 1112 is consistent from the first end 1282 to the second end 1284. The second exemplary spring 1112 can be used in place of spring 112.

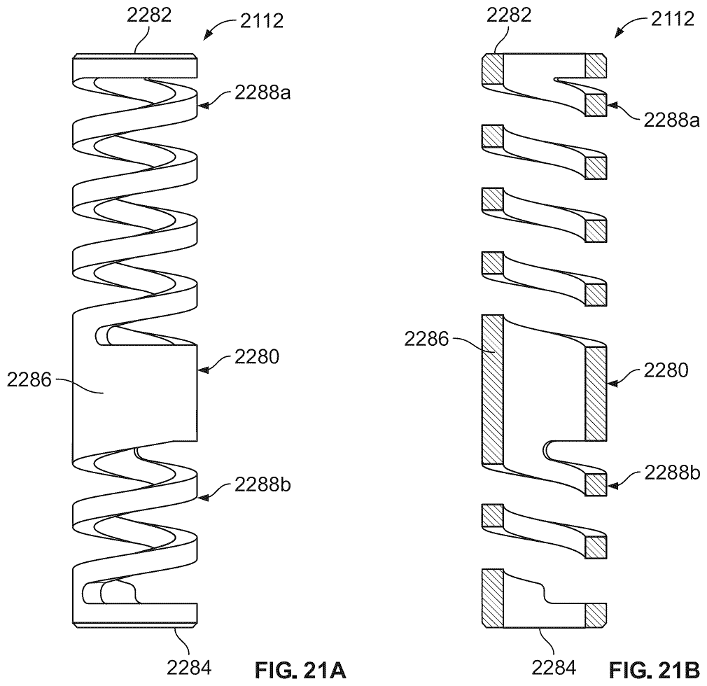

FIG. 21A is a side view of a third exemplary spring 2112 and FIG. 21B is a sectional view of the third exemplary spring 2112. The third exemplary spring 2112 includes a coiled body 2280 that extends from a first end 2282 to a second end 2284. The third exemplary spring 2112 is a linear compression spring that can be injection molded with an offset gate 2286 and two spring portions 2288a, 2288b extending outward from the offset gate 2286 to the first and second ends 2282, 2284, respectively. Accordingly, the third exemplary spring 2112 can be substantially similar to the second exemplary spring 1112 shown and described in connection with FIGS. 20A-B, but includes an offset gate 2286, as opposed to a center gate that is positioned at the middle of the coiled body 2280. Thus, first and second spring portions 2288a, 2288b of the third exemplary spring 2112 are of different lengths. The third exemplary spring 2112 can be used in place of spring 112.

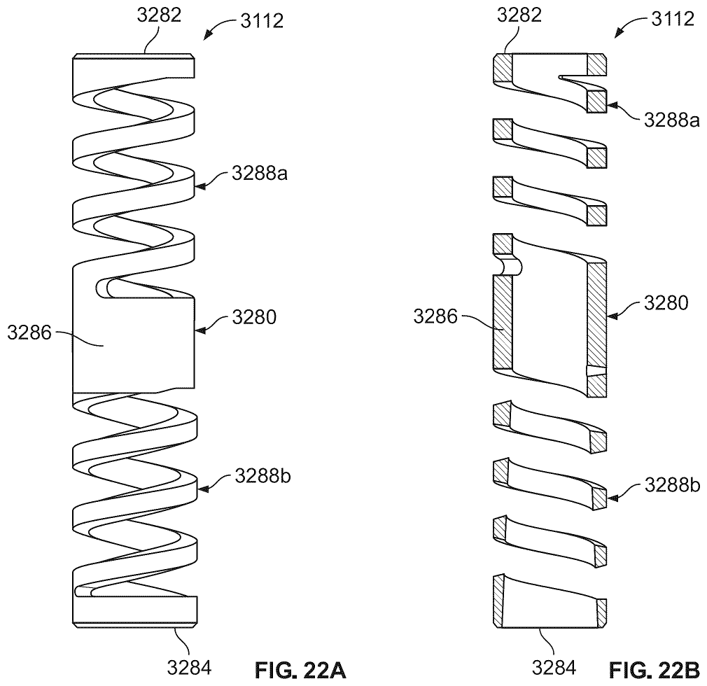

FIG. 22A is a side view of a fourth exemplary spring 3112 and FIG. 22B is a sectional view of the fourth exemplary spring 3112. The fourth exemplary spring 3112 is essentially a combination of spring 112 and second exemplary spring 1112. In particular, a first half of the fourth exemplary spring 3112 has a tapered internal diameter with trapezoidal cross-section coils and a second half of the fourth exemplary spring 3112 has a straight uniform internal diameter with square cross-section coils. Accordingly, the fourth exemplary spring 3112 includes a coiled body 3280 that extends from a first end 3282 to a second end 3284. The fourth exemplary spring 3112 is a linear compression spring that can be injection molded with a center gate 3286 and two spring portions 3288a, 3288b extending outward from the center gate 3286 to the first and second ends 3282, 3284, respectively. The first spring portion 3288a has a straight uniform internal diameter with square cross-section coils, while the second spring portion 3288b has a tapered internal diameter with trapezoidal cross-section coils. The fourth exemplary spring 3112 can be used in place of spring 112.

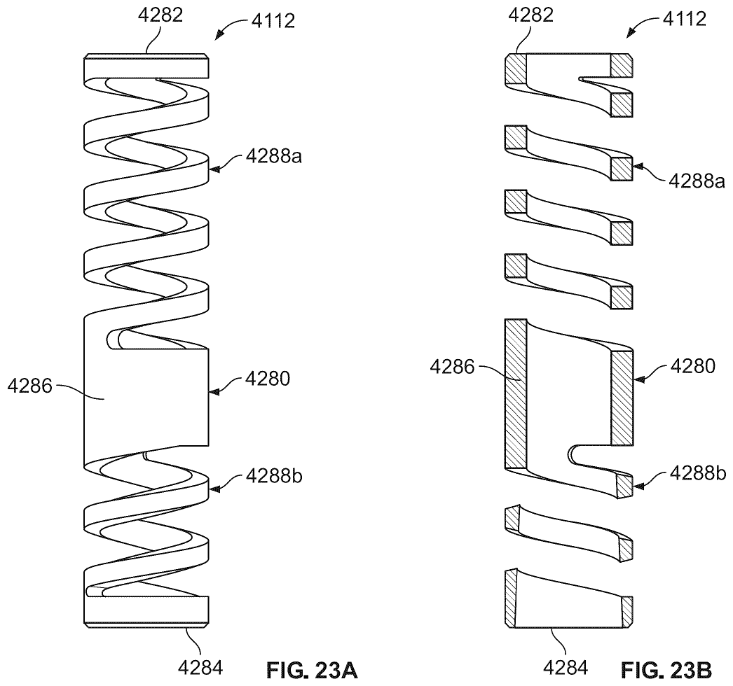

FIG. 23A is a side view of a fifth exemplary spring 4112 and FIG. 23B is a sectional view of the fifth exemplary spring 4112. The fifth exemplary spring 4112 is essentially a combination of the third exemplary spring 2112 and the fourth exemplary spring 3112. In particular, a first half of the fifth exemplary spring 4112 has a tapered internal diameter with trapezoidal cross-section coils, a second half of the fifth exemplary spring 4112 has a straight uniform internal diameter with square cross-section coils, and the first and second halves are separated by an offset gate 4286. Accordingly, the fifth exemplary spring 4112 includes a coiled body 4280 that extends from a first end 4282 to a second end 4284. The fifth exemplary spring 4112 is a linear compression spring that can be injection molded with an offset gate 4286 and two spring portions 4288a, 4288b extending outward from the offset gate 4286 to the first and second ends 4282, 4284, respectively. The first spring portion 4288a has a straight uniform internal diameter with square cross-section coils, while the second spring portion 4288b has a tapered internal diameter with trapezoidal cross-section coils. Since the offset gate 4286 is not positioned in the middle of the coiled body 4280, the first and second spring portions 4288a, 4288b of the fifth exemplary spring 4112 are of different lengths. The fifth exemplary spring 4112 can be used in place of spring 112.

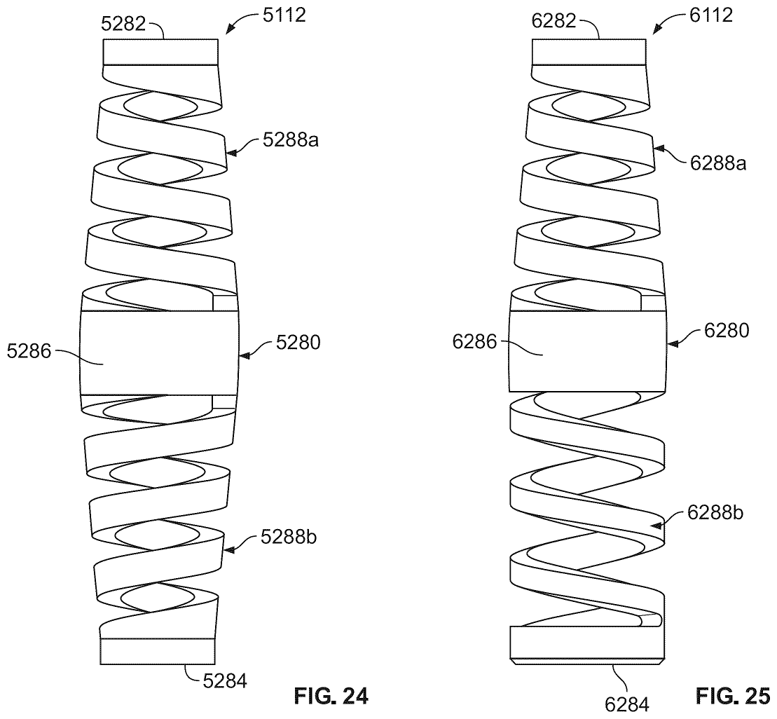

FIG. 24 is a side view of a sixth exemplary spring 5112. The sixth exemplary spring 5112 includes a coiled body 5280 that extends from a first end 5282 to a second end 5284. The sixth exemplary spring 5112 is a linear compression spring that can be injection molded with a center gate 5286 and two spring portions 5288a, 5288b extending outward from the center gate 5286 to the first and second ends 5282, 5284, respectively. The sixth exemplary spring 5112 can be substantially similar to the spring 112 shown and described in connection with FIGS. 16A-C, but with spring portions 5288a, 5288b that have a tapered internal diameter and a tapered external diameter that both decrease in diameter as the spring portions 5288a, 5288b extend from the center gate 5286 to the first and second ends 5282, 5284, respectively. The sixth exemplary spring 5112 can be used in place of spring 112.

FIG. 25 is a side view of a seventh exemplary spring 6112. The seventh exemplary spring 6112 includes a coiled body 6280 that extends from a first end 6282 to a second end 6284. The seventh exemplary spring 6112 is a linear compression spring that can be injection molded with a center gate 6286 and two spring portions 6288a, 6288b extending outward from the center gate 6286 to the first and second ends 6282, 6284, respectively. The seventh exemplary spring 6112 can be substantially similar to the spring 112 shown and described in connection with FIGS. 16A-C, but with a first spring portion 6288a that has a tapered internal diameter and a tapered external diameter that both decrease in diameter as the first spring portion 6288a extends from the center gate 6286 to the first end 6282, and a second spring portion 6288b that has straight and uniform internal and external diameters that do not change as the second spring portion 6288b extends from the center gate 6286 to the second end 6284. Additionally, the first spring portion 6288a has a trapezoidal coil cross-section, while the second spring portion 6288b has a square coil cross-section. The seventh exemplary spring 6112 can be used in place of spring 112.

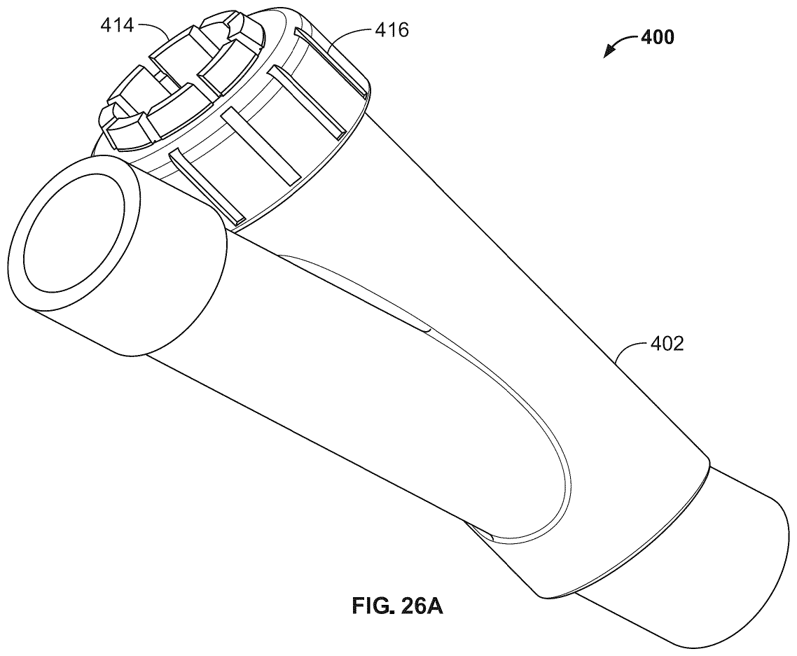

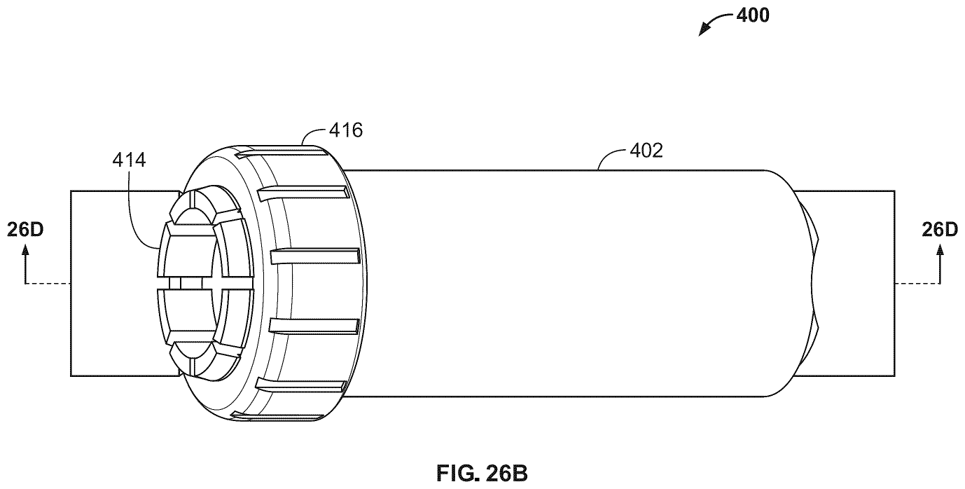

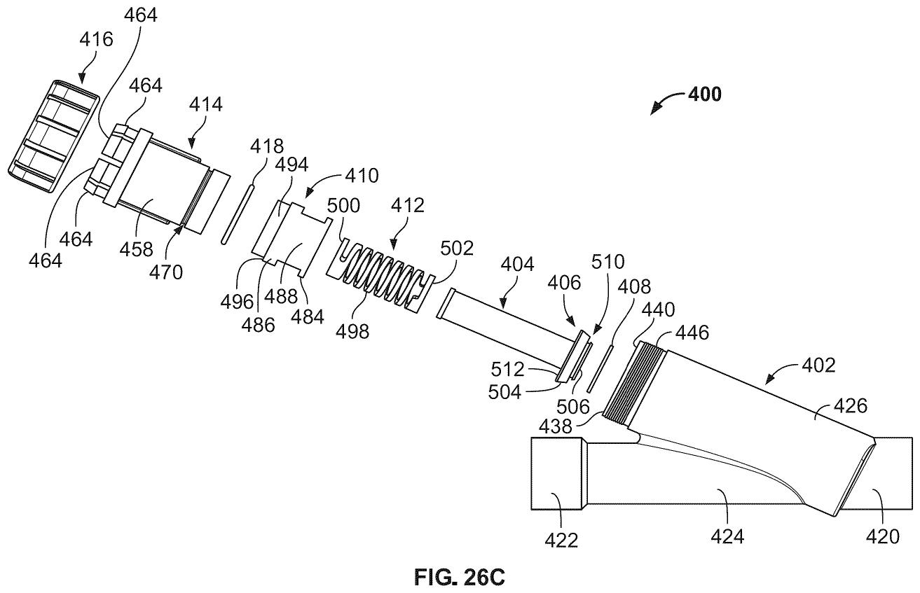

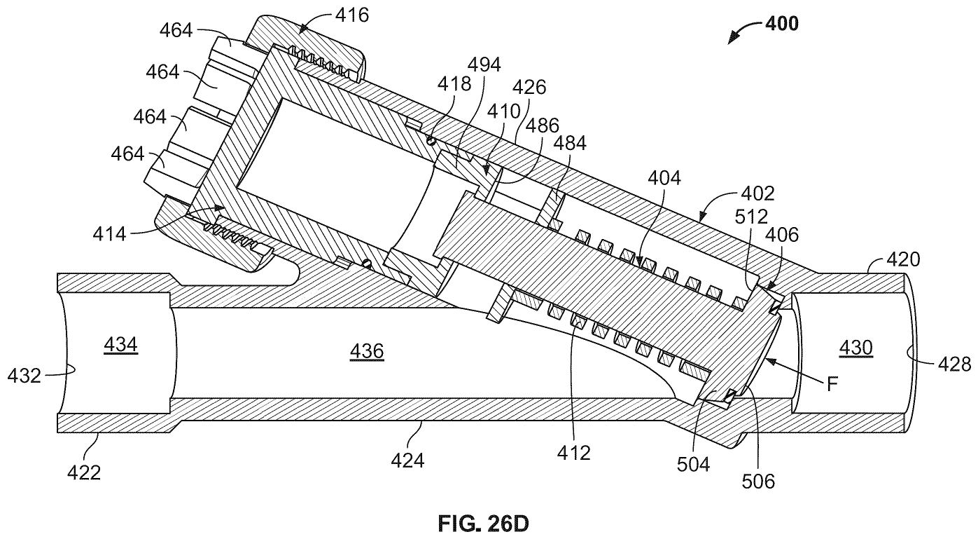

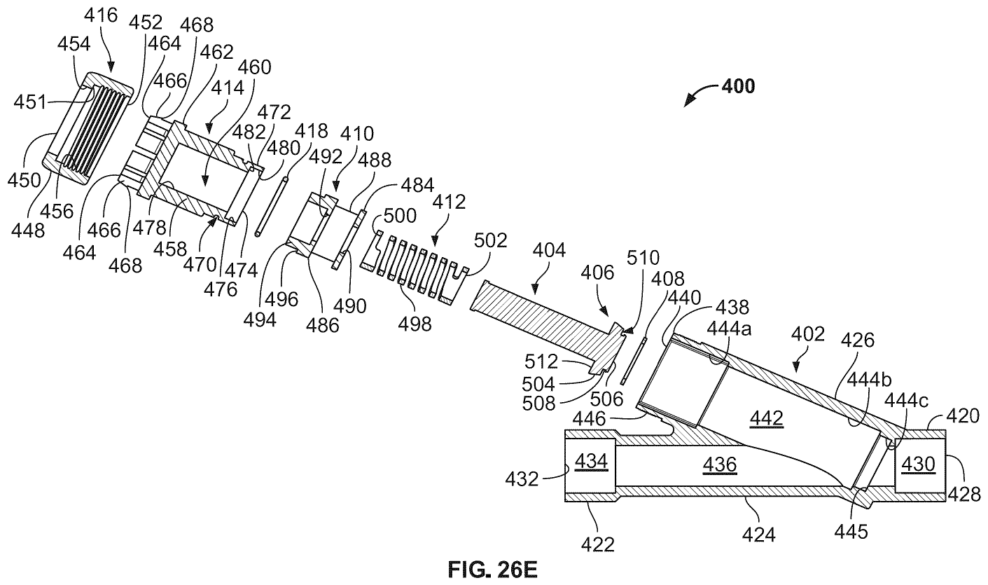

FIGS. 26A-26E illustrate another exemplary Y-check valve 400 of the present disclosure. FIG. 26A is a bottom perspective view of the Y-check valve 400 while FIG. 26B is a top view of the Y-check valve 400. FIG. 26C is an exploded view of the Y-check valve 400. FIG. 26D is a sectional view of the Y-check valve 400 taken along line 26D-26D of FIG. 26B, and FIG. 26E is an exploded view of FIG. 26D, e.g., FIG. 26E is an exploded sectional view of the Y-check valve 400. The Y-check valve 400 shown and described in connection with FIGS. 26A-26E is similar to the Y-check valve 100 shown and described in connection with FIGS. 1-18B. Accordingly, similarly named components should be understood to have similar construction and functionality except where noted and described.

The Y-check valve 400 includes a body 402, a poppet valve stem 404, a plug 406, a plug seal 408, a stem guide 410, a spring 412, a retainer 414, a barrel nut 416, and a retainer seal 418. The body 402 of the Y-check valve 400 is substantially similar to the body 102 of the Y-check valve 100 shown and described in connection with FIGS. 5A and 5B, and all details thereof need not be repeated. The body 402 includes an inlet port 420, an outlet port 422, a central portion 424, and a barrel leg 426. The inlet port 420 can be generally tubular in shape and defines an inlet opening 428 and an inlet flow chamber 430 while the outlet port 422 can also be generally tubular in shape and defines an outlet opening 432 and an outlet flow chamber 434. The central portion 424 extends between the inlet port 420 and the outlet port 422, and defines a central flow chamber 436 that is in fluidic communication with the inlet flow chamber 430 and the outlet flow chamber 434.

As can be seen in FIG. 26E, the barrel leg 426 includes an open end 438 defining an opening 440 in fluidic communication with a central chamber 442 that is defined by a series of three internal bores 444a-c of decreasing diameter. The open end 438 of the barrel leg 426 includes external threads 446 that are configured to engage internal threads 456 of the barrel nut 416 to assemble the Y-check valve 400 and secure the working valve components, e.g., the poppet valve stem 404, plug 406, plug seal 408, stem guide 410, spring 412, retainer 414, and retainer seal 418, within the barrel leg 426.

The barrel nut 416 can be similar in construction to the barrel nut 116 shown and described in connection with FIGS. 9A-9D. The barrel nut 416 includes an annular body 448 having a top opening 450 and a bottom opening 452. The top opening 450 is formed by a bore having a straight internal wall 454 that extends from the top opening 450 to an internal shoulder 451, as opposed to an angled internal wall such as the chamfered wall 210 of barrel nut 116. The barrel nut 416 additionally includes internal threads 456 that are configured to engage the external threads 446 of the barrel leg 426 to assemble the Y-check valve 400 and secure the working valve components, e.g., the poppet valve stem 404, plug 406, plug seal 408, stem guide 410, spring 412, retainer 414, and retainer seal 418, within the barrel leg 426.

The retainer 414 can be similar in construction to the retainer 114 shown and described in connection with FIGS. 8A-8D. The retainer 414 includes a generally cylindrical unitary body 458 that defines an internal chamber 460. The retainer 414 includes an end disc 462 having a plurality of pliable fingers 464 that extend therefrom and each include a chamfered head 466 forming an outwardly extending shoulder 468. The chamfered heads 466 facilitate insertion of the pliable fingers 464 into the barrel nut 416. In particular, the barrel nut 416 can be connected to the retainer 414 by placing the barrel nut 416 over the retainer 414 such that the internal wall 454 surrounds and engages the chamfered heads 466 of the pliable fingers 464 of the retainer 414. Pressure can be continuously applied to the barrel nut 416 and the retainer 414 to cause the pliable fingers 464 to bend inwards, with the chamfered heads 466 acting as a cam ramp, until the pliable fingers 464 snap over the barrel nut 416. At this point, the barrel nut 416, e.g., the internal wall 454, is trapped between the outwardly extending shoulders 468 of the pliable fingers 464 and the end disc 462.

The retainer 414 additionally includes a circumferential channel 470 that extends into the exterior of the body 458. The circumferential channel 470 is configured to receive and house the retainer seal 418, which can be an o-ring or other gasket. The retainer seal 418 is generally compressed within the circumferential channel 470 between the body 458 of the retainer 414 and the inner surface of the second bore 444b of the barrel leg 426 when the retainer 414 is inserted into the barrel leg 426. The retainer 414 includes an open end 472 defining an opening 474 in communication with the internal chamber 460, which is configured to receive a portion of the poppet valve stem 404, for example, when the Y-check valve 400 is in a second position, e.g., an open position. The internal chamber 460 is defined by first and second bores 476, 478. The first bore 476 is positioned immediately adjacent the opening 474 and is defined by a first inner cylindrical wall 480 and an internal radial shoulder 482. The internal radial shoulder 482 is configured to prevent further insertion of the stem guide 410 into the internal chamber 460 of the retainer 414 and thus ensures proper placement thereof. The second bore 478 has a smaller diameter than the first bore 476.

The stem guide 410 includes a spring engagement disc 484 connected to a top disc 486 by a plurality of separated walls 488. The spring engagement disc 484 includes a first central aperture 490 while the top disc 486 includes a corresponding second central aperture 492 that is linearly aligned with the first central aperture 490. The first and second central apertures 490, 492 are configured to receive, retain, and guide the poppet valve stem 404, while the spring engagement disc 484 is configured to engage the spring 412 and provide a surface against which the spring 412 can be compressed. The top disc 486 also includes a reduced diameter neck 494 and radial shoulder 496 surrounding the reduce diameter neck 494. The reduced diameter neck 494 is configured to be inserted into the first bore 476 of the retainer 414 and engage the internal radial shoulder 482 to prevent further insertion of the stem guide 410 into the internal chamber 460 of the retainer 414. It is additionally noted that the stem guide 410 can be engaged with the retainer 414 in similar fashion to the retainer 114 and the retainer end cap 108, e.g., using a snap-fit connection, twist lock connection, etc.

The spring 412 includes a spring body 498 that extends between a first end 500 and a second end 502. The spring 412 is configured to be positioned and compressed between the spring engagement disc 484 of the stem guide 410 and the plug 406. The spring 412 can be provided as any one of springs 112, 1112, 2112, 3112, 4112, 5112, 6112 shown and described in connection with FIGS. 16A-16C, 20A-20B, 21A-21B, 22A-22B, 23A-23B, 24, and 25.

The poppet valve stem 404 is a cylindrical component having the plug 406 connected to an end thereof. The plug 406 includes a frustoconical body 504, a head 506, and a neck 508 connecting the head 506 to the frustoconical body 504. A circumferential groove 510 is formed between the frustoconical body 504 and the head 506. The circumferential groove 510 receives the plug seal 408, which is configured to be compressed within the circumferential groove 510 between the neck 508 and an internal end wall 445 at the end of the third bore 444c of the barrel leg 426 when the Y-check valve 400 is in the first position, e.g., the closed position. The frustoconical body 504 forms a radial shoulder 512 against which the spring 412 is compressed. In this regard, the poppet valve stem 404 is inserted into the spring 412 and through the central apertures 490, 492 of the stem guide 410 such that the spring 412 is positioned and compressible between the spring engagement disc 484 of the stem guide 410 and the radial shoulder 512 of the plug 406.

As can be seen in FIG. 26D, when the Y-check valve 400 is fully assembled and in the first position, e.g., the closed position, the spring 412 forces the plug 406 toward the internal end wall 445 at the end of the third bore 444c of the barrel leg 426 causing the plug seal 408 to be compressed between the internal end wall 445 and the plug 504, which results in the creation of a seal between the plug 504 and the internal end wall 445 of the barrel leg 426. The plug seal 408 can be a face seal. Additionally, a seal is also formed between the retainer 414 and the second bore 444b of the barrel leg 426 by way of the retainer seal 418, which is compressed therebetween. Accordingly, the plug 504 and plug seal 408 prevent fluid from flowing from the inlet port 420 of the body 402 to the outlet port 422, e.g., through the inlet flow chamber 430 and into the central flow chamber 436 and the outlet flow chamber 434. Furthermore, when the Y-check valve 400 is in the first position, fluid is prevented from flowing in the reverse direction therethrough. That is, the plug 406 and plug seal 408 also prevent fluid from flowing from the outlet port 422 of the body 402 to the inlet port 420, e.g., any fluid that is in the outlet flow chamber 434 or the central flow chamber 436 is prevented from flowing into the inlet flow chamber 430. It is also noted that any fluid pressure downstream of the Y-check valve 400 enhances the seal between the plug 406, the plug seal 408, and the internal end wall 445 of the barrel leg 426, as such pressure would act on the radial shoulder 512 of the plug 406 and force the disc plug 406 to further seat against the internal end wall 445 and compress the plug seal 408.

Once forward flow in the piping system is started, e.g., due to the activation of a pump in the piping system, fluid enters the Y-check valve 400 through the inlet opening 428 of the inlet port 420 of the body 402. The pressure and flow generated by the pump imparts a force F on the plug 406, which causes the plug 406 to open. In particular, the force F imparted on the plug 406 breaks the seal between the plug seal 408, the plug 406, and the internal end wall 445 of the barrel leg 426 and causes the spring 412 to compress between the spring engagement disc 484 of the stem guide 410 and the radial shoulder 512 of the plug 406, which results in the translation of the poppet valve stem 404 and the plug 406 along the axis of the barrel leg 426 toward the retainer 414. In this regard, the poppet valve stem 404 is forced through the apertures 490, 492 of the stem guide 410 and into the internal chamber 460 of the retainer 414. Compression of the spring 412 and translation of the poppet valve stem 404 and plug 406 results in fluid being permitted to flow into the central chamber 442 of the barrel leg 426, continue into the central and outlet flow chambers 436, 434, and exit the Y-check valve 400 through the outlet opening 432 at which point it enters the external piping system to which the Y-check valve 400 is installed.

When the pump is shutdown, the fluid flow to the Y-check valve 400 is stopped or severely reduced, which results in the force F imparted on the plug 406 reducing in magnitude. In particular, the force F on the plug 406 reduces to a level that gravity and the spring bias of the spring 412 are able to overcome. Accordingly, the spring 412 overcomes the forward momentum of the fluid causing the plug 406 to close such that a seal is once again formed between the plug 406, the plug seal 408, and the internal end wall 445 of the barrel leg 426 as the plug seal 408 is compressed, which prevents the backflow of fluid through the Y-check valve 400. Fluid from the piping system downstream of the Y-check valve 400 fills the outlet flow chamber 434, the central flow chamber 436, and the central chamber 442 of the barrel leg 402, but does not leak into the inlet flow chamber 430. No additional fluid passes through the Y-check valve 400 until forward flow is resumed, e.g., upon activation of the pump.

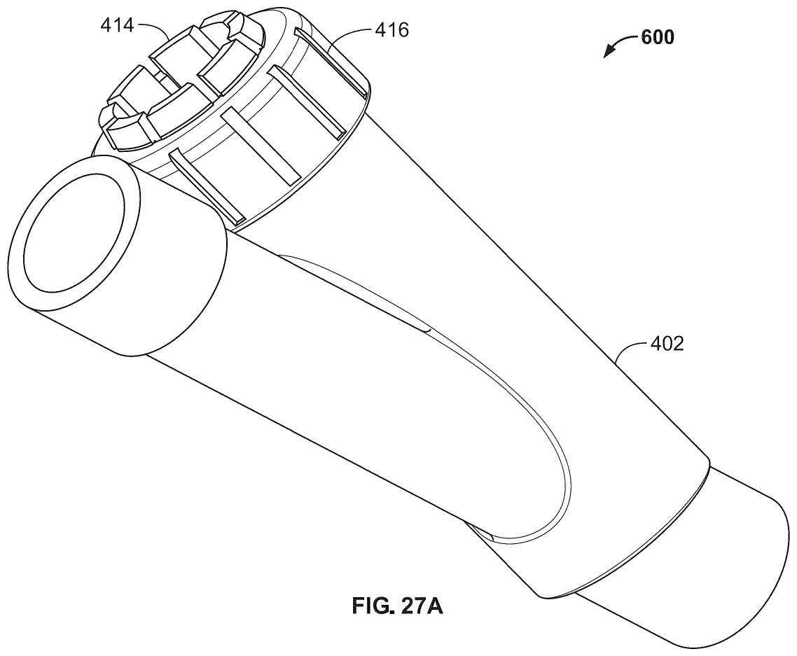

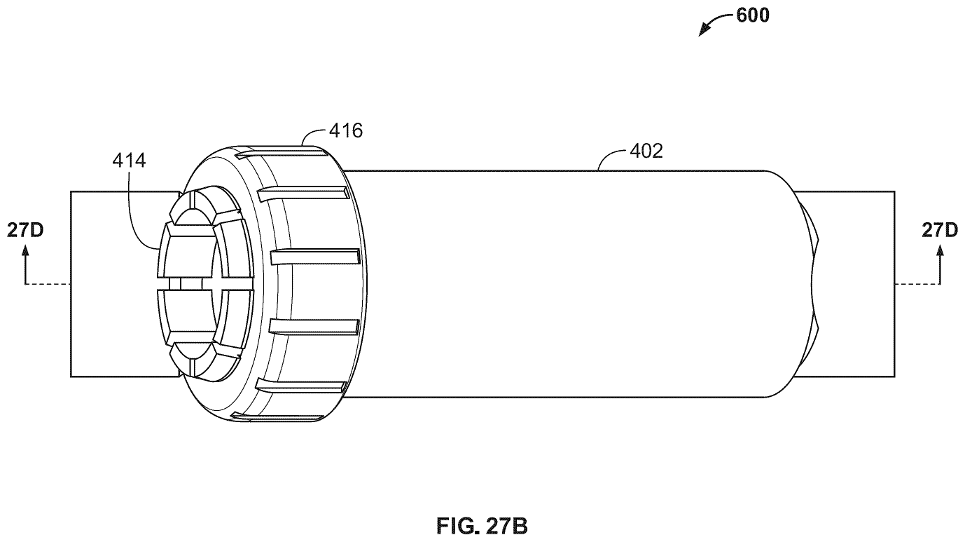

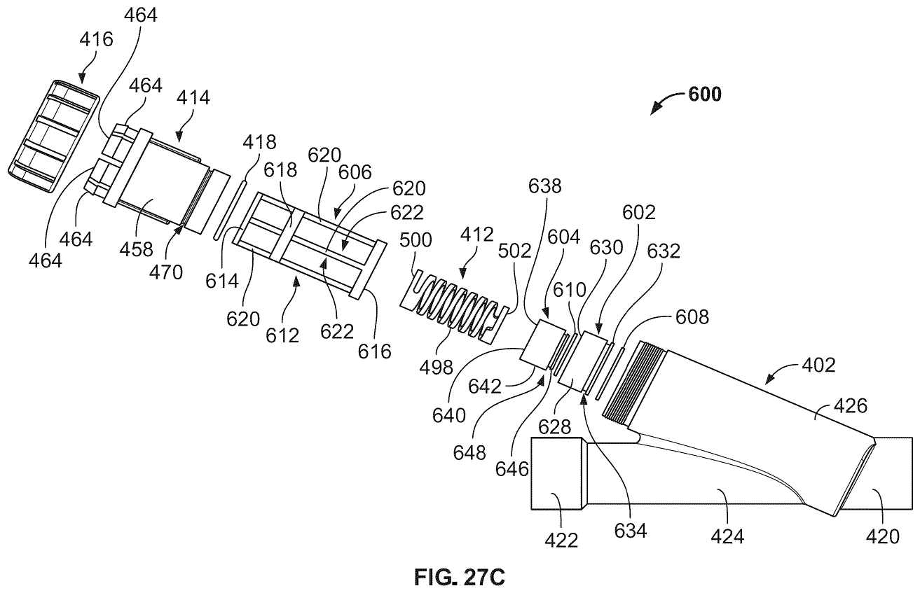

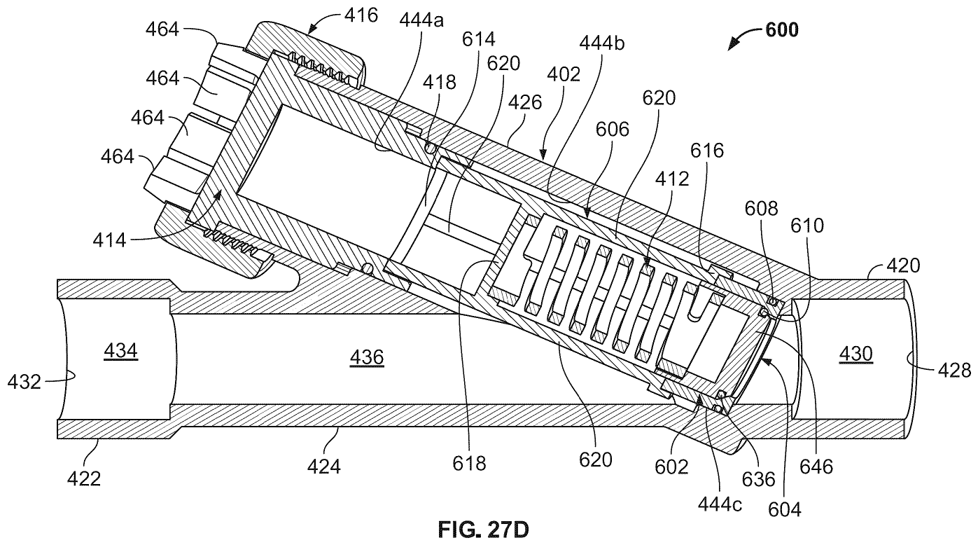

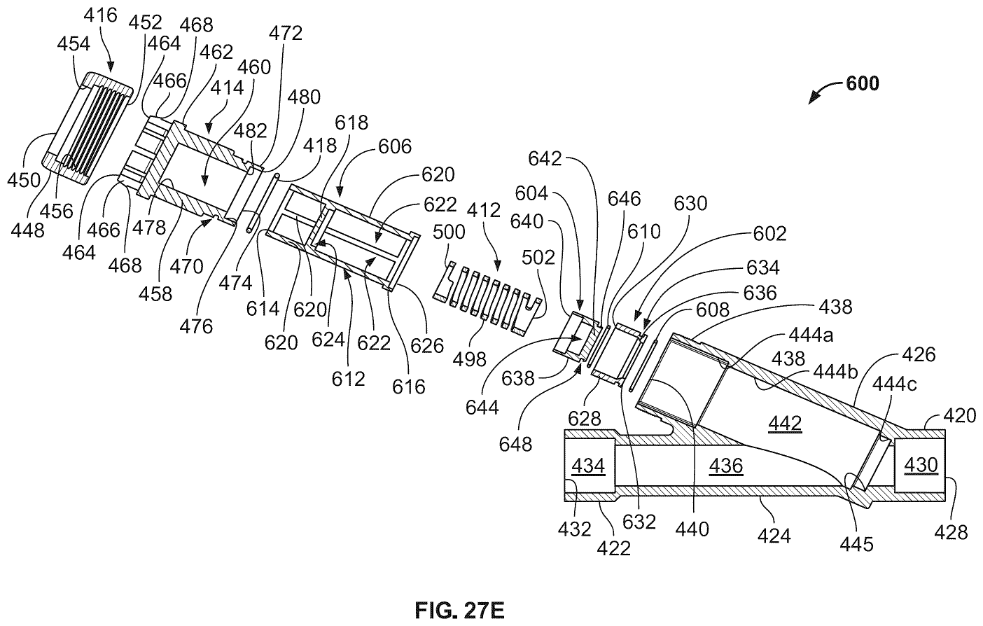

FIGS. 27A-27E illustrate another exemplary Y-check valve 600 of the present disclosure. FIG. 27A is a bottom perspective view of the Y-check valve 600 while FIG. 27B is a top view of the Y-check valve 600. FIG. 27C is an exploded view of the Y-check valve 600. FIG. 27D is a sectional view of the Y-check valve 600 taken along line 27D-27D of FIG. 27B, and FIG. 27E is an exploded view of FIG. 27D, e.g., FIG. 27E is an exploded sectional view of the Y-check valve 600. The Y-check valve 600 shown and described in connection with FIGS. 27A-27E is similar to the Y-check valve 100 shown and described in connection with FIGS. 1-18B. Additionally, the Y-check valve 600 of FIGS. 27A-27E includes similar components to the Y-check valve 400 of FIGS. 26A-26E Accordingly, similarly named and/or labelled components should be understood to have similar construction and functionality except where noted and described.

The Y-check valve 600 includes the body 402, the spring 412, the retainer 414, the barrel nut 416, and the retainer seal 418 of the Y-check valve 400 shown and described in connection with FIGS. 26A-26E, as well as a disc seal end cap 602, a disc 604, a cage 606, a cage seal 608, and a disc seal 610. Details regarding the body 402, the spring 412, the retainer 414, the barrel nut 416, and the retainer seal 418 are not repeated in connection with Y-check valve 600, but, instead, reference is made to the description provided in connection with FIGS. 26A-26E.

The cage 606 includes a frame-like body 612 having a first annular ring 614 positioned at a first end, a second annular ring 616 positioned at a second opposite end, and an intermediate wall 618 interconnected by a plurality of ribs 620 that extend from the first annular ring 614 to the second annular ring 616. The plurality of ribs 620 form a plurality of windows 622 through which the spring 412 and disc 604 can be inserted into the cage 606. The intermediate wall 618 can be formed as a cylindrical plate and is configured to engage the spring 412 and provide a surface against which the spring 412 can be compressed. In this regard, the intermediate wall 618 can include a bore 624 that is configured to receive and position the spring 412. The second annular ring 616 includes a bore 626 that is configured to receive and position the disc seal end cap 602. In this regard, the disc seal end cap 602 can be attached to the cage 606, either permanently, e.g., via spin welding, solvent cement, etc., or removably, e.g., via snap-fit connection, twist lock connection, lug and groove connection, etc. Likewise, the cage 606 can be attached to the retainer 414. In this regard, the first annular ring 614 of the cage 606 is configured to be inserted into the first bore 476 of the retainer 414 and engage the internal radial shoulder 482 to prevent further insertion of the cage 606 into the internal chamber 460 of the retainer 414. The cage 606 can be engaged with the retainer 414 in similar fashion to the retainer 114 and the retainer end cap 108, e.g., using a snap-fit connection, twist lock connection, lug and groove connection, etc.

The disc seal end cap 602 includes a generally cylindrical hollow body 628 defining a first opening 630 and a second opening 632. The generally cylindrical hollow body 628 includes an exterior circumferential channel 634 that extends into the exterior of the body 628, and an internal chamfer 636. The exterior circumferential channel 634 is configured to receive and house the cage seal 608, which can be an o-ring or other gasket. The cage seal 608 is generally compressed within the exterior circumferential channel 634 between the body 628 of the disc seal end cap 602 and the inner surface of the third bore 444c of the barrel leg 426 when the disc seal end cap 602 is inserted into the barrel leg 426, thus sealing the disc seal end cap 602 with the third bore 444c of the barrel leg 426. The internal chamfer 636 is positioned adjacent the second opening 632 and provides a sealing surface for the disc seal 610 to be compressed against by the disc 604 and seal against when the Y-check valve 600 is in the first position, e.g., the closed position. Accordingly, the disc seal end cap 602 functions to provide a sealing surface for the disc seal 610.

The disc 604 can be similar in construction to the disc 110 discussed in connection with FIGS. 15A-15D. In particular, the disc 604 includes a cylindrical body 638 that extends between an open end 640 and a closed end 642, and defines an internal chamber 644 that receives a portion of the spring 412. A frustoconical head 646 is connected to the closed end 642 by a neck forming a circumferential groove 648 between the closed end 642 and the head 646. The circumferential groove 648 receives the disc seal 610, which is configured to be compressed within the circumferential groove 648 between the neck and the internal chamfer 636 of the body 628 of the disc seal end cap 602 when the Y-check valve 600 is in the first position, e.g., the closed position. In this regard, the frustoconical head 646 is sized and shaped to be inserted within the internal chamfer 636 so as to not impede sealing of the disc seal 610 with the internal chamfer 636.

The Y-check valve 600 is configured such that when the retainer 414, the cage 606, and the disc seal end cap 602 are connected (e.g., permanently or removably), the spring 412 and disc 604 can be inserted into the cage 606 and the disc seal end cap 602 through the windows 622 to interconnect the spring 412 with the cage 606, e.g., to engage the spring 412 with the intermediate wall 618, and the disc 604 with the disc seal end cap 602. Accordingly, when the spring 412 and the disc 604 are inserted into the cage 606 and the disc seal end cap 602, the spring 412 engages the intermediate wall 618 of the cage 606 and forces the disc 604 toward the disc seal end cap 602, causing the disc seal 610 to be compressed between the disc 604 and the internal chamfer 636 of the disc seal end cap 602.

The Y-check valve 600 shown and described in connection with FIGS. 27A-27E functions in substantially the same way as the Y-check valve 100 shown and described in connection with FIGS. 1-18B and the Y-check valve 400 shown and described in connection with FIGS. 26A-26E. Accordingly, details concerning operation thereof need to be repeated.

In some embodiments, all or some of the components of the Y-check valves 100, 400, 600 can be fabricated from, e.g., polyvinyl chloride (PVC), chlorinated polyvinyl chloride (CPVC), glass-filled polypropylene (GFPP), polyvinylidene fluoride (PVDF), and the like. However, the design of the Y-check valves 100, 400, 600 discussed herein should not be limited to the field of thermoplastics and can be adapted to products constructed from metal or other materials. For example, some components can be fabricated from an elastomeric material, e.g., an ethylene propylene diene monomer (EPDM), a fluoropolymer elastomer (FPM), a nitrile rubber (NBR), materials with resiliency of elastomers, materials with more or less resiliency than elastomers, and the like.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A Y-check valve for installation in a piping system, comprising:
a body having an inlet port, an outlet port, a central portion extending between the inlet port and the outlet port, and a barrel leg, the central portion defining a first chamber placing the inlet port in fluidic communication with the outlet port and the barrel leg defining a second chamber that is in fluidic communication with the first chamber;
a nut removably fastened to a distal end of the barrel leg;
a retainer coupled to the nut and at least partially positioned within the second chamber defined by the barrel leg;
a retainer seal forming a seal between the retainer and the barrel leg;
a cage subassembly including a sealing surface and a cage having a cylindrical body with a plurality of openings extending therethrough, the cage subassembly being engaged with the retainer, positioned within the second chamber defined by the barrel leg, and forming a seal with an inner wall of the barrel leg;
a disc positioned within the cage subassembly, the disc being movable between (i) a first position in which the disc sealingly engages the sealing surface of the cage subassembly and prevents backflow of fluid through the body, and (ii) a second position in which the disc does not sealingly engage the sealing surface and fluid is permitted to flow through the body; and
a spring positioned within the cage subassembly, the spring biasing the disc into the first position.

2. The Y-check valve of claim 1, wherein the barrel leg interconnects with the central portion at an acute angle.

3. The Y-check valve of claim 1, wherein the retainer includes a counter-bore defining an internal chamber, and
wherein the spring is at least partially inserted into the internal chamber and retained by the retainer.

4. The Y-check valve of claim 3, wherein the spring engages an interior surface of the retainer and is compressible between the disc and the interior surface of the retainer.

5. The Y-check valve of claim 4, wherein the retainer guides compression of the spring and prevents lateral displacement of the spring.

6. The Y-check valve of claim 1, wherein the spring and the disc are integrally formed as a single unit.

7. The Y-check valve of claim 1, wherein the cage subassembly comprises:
a retainer end cap engaged with a first end of the cylindrical body and interconnecting the cage subassembly with the retainer; and
a disc seal end cap engaged with a second end of the cylindrical body, the disc seal end cap including the sealing surface.

8. The Y-check valve of claim 7, wherein the retainer end cap is spin welded to the cylindrical body and the disc seal end cap is spin welded to the cylindrical body.

9. The Y-check valve of claim 7, comprising a cage seal positioned about the disc seal end cap, the cage seal forming a seal between the disc seal end cap and the inner wall of the barrel leg.

10. The Y-check valve of claim 1, wherein the disc includes an annular channel that receives a disc seal, the disc seal forming a seal between the disc and the sealing surface of the cage subassembly when the disc is in the first position.

11. The Y-check valve of claim 10, wherein the disc includes a head extending from an end wall, the annular channel is defined between the head and the end wall, the head retains the disc seal in the annular channel when the disc is in the first position, and the end wall retains the disc seal in the annular channel when the disc is in the second position.

12. The Y-check valve of claim 10, wherein the disc defines an internal cup that receives fluid when the disc is in the first position and enhances the seal between the disc seal, the disc, and the sealing surface.

13. The Y-check valve of claim 1, wherein the body includes a fillet between the barrel leg and the outlet port or the barrel leg and the central portion.

14. The Y-check valve of claim 1, wherein the barrel leg includes an open end in fluidic communication with the second chamber defined by the barrel leg and threads on an exterior of the open end, and
wherein the nut includes interior threads configured to engage the threads on the exterior of the open end of the barrel leg.

15. The Y-check valve of claim 14, wherein the exterior threads of the barrel leg are configured to expand into the interior threads of the nut when there is a surge of pressure in the barrel leg.

16. The Y-check valve of claim 15, wherein the exterior threads and the interior threads are buttress threads.

17. The Y-check valve of claim 1, wherein the cage subassembly comprises:
a retainer end cap engaged with a first end of the cylindrical body and interconnecting the cage subassembly with the retainer,
wherein the retainer end cap is removably engaged with the retainer.

18. The Y-check valve of claim 17, wherein the retainer end cap is removably engaged with the retainer with a snap-fit connection.

19. The Y-check valve of claim 1, wherein unfastening of the nut causes the retainer, the cage subassembly, the disc, and the spring to be drawn out from the second chamber defined by the barrel leg, and a pressure relief passage to be formed.

20. The Y-check valve of claim 1, wherein unfastening of the nut causes the seal between the retainer and the barrel leg formed by the retainer seal to be broken and a pressure relief passage to be formed.

21. The Y-check valve of claim 20, wherein the retainer seal is a piston seal or a face seal.

22. The Y-check valve of claim 1, wherein the retainer seal is positioned about a portion of the retainer and forms a seal between the retainer and an interior wall of the barrel leg when the retainer is positioned within the second chamber defined by the barrel leg.

23. The Y-check valve of claim 22, wherein the barrel leg includes a first bore, a second bore, and a chamfer between the first bore and the second bore, and
wherein the retainer seal forms a seal between the retainer and the second bore.

24. The Y-check valve of claim 23, wherein unfastening of the nut causes the retainer, the cage subassembly, the disc, the spring, and the retainer seal to be drawn out from the second chamber defined by the barrel leg.

25. The Y-check valve of claim 24, wherein the retainer seal traverses the chamfer when the nut is unfastened and the retainer, the cage subassembly, the disc, the spring, and the retainer seal are drawn out from the second chamber defined by the barrel leg, and
a passage is formed between the retainer seal and the first bore when the retainer seal traverses the chamfer, the passage allowing pressure within the barrel leg to be relieved therethrough.

26. The Y-check valve of claim 25, wherein the nut remains fastened to the distal end of the barrel as the retainer seal traverses the chamfer and the passage is formed.

27. The Y-check valve of claim 22, wherein the retainer seal is a piston seal, and the distal end of the barrel leg is isolated from pressure within the second chamber defined by the barrel leg by the retainer seal.

28. The Y-check valve of claim 1, wherein the nut, the retainer, the cage subassembly, the disc, and the spring are removable from the barrel leg as a single unit.

29. The Y-check valve of claim 1, wherein the retainer includes first and second annular shoulders defining an annular channel therebetween, the annular channel configured to receive a portion of the nut and permanently connect the nut and the retainer.

30. The Y-check valve of claim 29, wherein the nut includes a top opening and a chamfered wall about the top opening, and
wherein the nut and the retainer are permanently connected by engaging the chamfered wall with the first annular shoulder of the retainer and forcing the first annular shoulder through the top opening causing the chamfered wall to snap over the first annular shoulder and into the annular channel.

31. The Y-check valve of claim 30, wherein the nut is capable of rotating freely about the retainer.

32. The Y-check valve of claim 1, wherein the body includes a first tapped hole upstream of the barrel leg and a second tapped hole downstream of the barrel leg, the first and second tapped holes being configured to each receive a pressure sensing device to measure differential pressure across the barrel leg.

33. The Y-check valve of claim 1, wherein the spring is injection molded.

34. The Y-check valve of claim 33, wherein the spring is injection molded with a gate, a first spring portion extending from the gate to a first end, and a second spring portion extending from the gate to a second end.

35. The Y-check valve of claim 34, wherein the gate is at a center of the spring.

36. The Y-check valve of claim 34, wherein the first spring portion and the second spring portion have different internal diameters and/or different external diameters.

37. The Y-check valve of claim 34, wherein at least one of an internal diameter of the first spring portion, an internal diameter of the second spring portion, an external diameter of the first spring portion, and an external diameter of the second spring portion is tapered.

38. The Y-check valve of claim 34, wherein the first spring portion includes a trapezoidal cross-section or a square cross-section, and the second spring portion includes a trapezoidal cross-section or a square cross-section.

39. The Y-check valve of claim 33, wherein the spring is injection molded with an end gate and a variably decreasing cross-section.
